(19) United States
(12) Patent Application Publication
(10) Pub. No.: US 2014/0304244 A1
(43) Pub. Date: Oct. 9, 2014

(54) Anonymization Index Determination Device and Method, and Anonymization Process Execution System and Method

(71) Applicant: Yuki Toyoda, Tokyo (JP)

(72) Inventor: Yuki Toyoda, Tokyo (JP)

(73) Assignee: NEC CORPORATION, Tokyo (JP)

(21) Appl. No.: 14/128,456

(22) PCT Filed: Jun. 20, 2012
(86) PCT No.: PCT/JP2012/066305

§ 371 Date: Dec. 20, 2013

(30) Foreign Application Priority Data
Jun. 20, 2011 (JP) 2011-136488

(51) Int. Cl. G06F 17/30

(52) U.S. Cl. CPC G06F 17/30336
USPC 707/696

(57) ABSTRACT

An appropriate index value for guaranteeing the anonymity of data is specified, even when the data number of data included in a predetermined group increases and decreases with time.

An anonymization index determination device: specifies, with regards to data having an attribute, the data number of data having each attribute at each time within a predetermined period; calculates for each threshold value the number of times the data number of data having one attribute is equal to or greater than a given threshold value at a first time and less than the threshold at a second time; calculates a score for each threshold value on the basis of the calculated number of times; specifies an anonymization index, which is a threshold value specified on the basis of the score; and specifies data having the one attribute and the aforementioned other attribute as data to be updated to commonized attribute when the data number of data having a given attribute is less than the anonymization index and the sum of the noted data number of data and the data number of data having one or more other attributes is equal to or greater than the anonymization index.

### FIELD OF THE INVENTION

The present invention relates to a technology which determines an appropriate value of an index used for anonymization processing of data.

### BACKGROUND OF THE INVENTION

A technology to balance anonymity and utility of a data is known for anonymizing (anonymization) of at least a part of information of a data like personal information. Anonymization is to process information which can specify an individual and to updates it to information which cannot specify an individual.

For example, a technology described in patent document 1 groups data for each predetermined attribute possessed by the data. Then, the technology judges whether it anonymizes processing or not on the basis of whether the data number of data included in the group is or not lower than a predetermined threshold value after grouping.
[Patent document 1] Japanese Patent Application Laid-Open No. 2010-086179

### SUMMARY OF THE INVENTION

### Problems to be Solved by the Invention

However, the technology described in the patent document 1 has the following problem. Namely, in the technology described in patent document 1, when the data number of data included in a group increases and decreases to sandwich a threshold value, data included in the group is anonymized or not anonymized according to the time. In that case, the technology described in the patent document 1 does not change the threshold value. That is, in the technology disclosed in patent document 1, on the basis of the contents of the data in the time when a certain data is not anonymized, the contents of the data in the time when the data is anonymized will be analogized. Accordingly, when a data number of data included in a predetermined group increases and decreases with time, the technology described in the patent document 1 cannot specify an appropriate index value (threshold value, for example) for guaranteeing the anonymity of the data.

One of objects of the present invention is to provide an anonymization index determination device, an anonymization processing execution system, an anonymization index determination method and an anonymization processing execution method which can specify an appropriate index value for guaranteeing anonymity of data even when a data number of data included in a predetermined group increases and decreases with time.

### Means for Solving the Problem

A first anonymization index determination device in one mode of the present invention including: data management means for managing data having an attribute; data number specification means for specifying the data number of data having the attribute at each time of a predetermined time for each attribute with regards to the data; score calculating means for calculating the number of times that the data number of data having one attribute is equal to or greater than the threshold values at a first time and is less than the threshold values at a second time in which unit time has passed from the first time to a plurality of threshold values, and calculating a score for each threshold value on the basis of the number of times; threshold value specification means for specifying an anonymization index from the plurality of threshold values on the basis of the score as one threshold value specified; and anonymization data specification means for specifying the data having the one attribute and other attribute as data to be updated to commonized attribute, when the data number of data having one attribute in the managed data is less than the anonymization index and the sum of the data number and the data number of data having at least one or more other attributes is equal to or greater than the anonymization index.

A first anonymization processing execution system in one mode of the present invention including; data management means for managing data having an attribute; data number specification means for specifying the data number of data having the attribute at each time of a predetermined time for each attribute with regards to the data; score calculating means for calculating the number of times that the data number of data having one attribute is equal to or greater than the threshold values at a first time and less than the threshold values at a second time in which unit time has passed from the first time to a plurality of threshold values, and calculating a score for each threshold value on the basis of the number of times; threshold value specification means for specifying an anonymization index from the plurality of threshold values on the basis of the score as one threshold value specified; anonymization data specification means for specifying the data having the one attribute and other attribute as data to be updated to commonized attribute, when the data number of data having one attribute in the managed data is less than the anonymization index and the sum of the data number and the data number of data having at least one or more other attributes is equal to or greater than the anonymization index; anonymization execution means for updating data which said anonymization data specification means specifies to the commonized attribute; and post-anonymization data storage means for storing the data which said anonymization execution means updates.

A first anonymization index determination method in one mode of the present invention including: managing data having an attribute; specifying the data number of data having the attribute at each time of a predetermined time for each attribute with regards to the data; calculating the number of times that the data number of data having one attribute is equal to or greater than the threshold values at a first time and less than the threshold values at a second time in which unit time has passed from the first time to a plurality of threshold values, and calculating a score for each threshold value on the basis of the number of times; specifying an anonymization index from the plurality of threshold values on the basis of the score as one threshold value specified; and specifying the data having the one attribute and the other attribute as data to be updated to commonized attribute, when the data number of data having one attribute in the managed data is less than the anonymization index and the sum of the data number and the data number of data having at least one or more other attributes is equal to or greater than the anonymization index.

A first anonymization processing execution method in one mode of the present invention including: managing data having an attribute; specifying the data number of data having the attribute at each time of a predetermined time for each attribute with regards to the data; calculating the number of times that the data number of data having one attribute is equal to or greater than the threshold values at a first time and less than the threshold values at a second time in which unit time has passed from the first time to a plurality of threshold values, and calculating a score for each threshold value on the basis of the number of times; specifying an anonymization index from the plurality of threshold values on the basis of the score as one a threshold value specified; specifying the data having the one attribute and the other attribute as data to be updated to commonized attribute, when the data number of data having one attribute in the managed data is less than the anonymization index and the sum of the data number and the data number of data having at least one or more other attributes is equal to or greater than the anonymization index; updating the specified data to the commonized attribute; and storing the updated data.

A first anonymization index determination program which causes a computer to execute processing in one mode of the present invention including: processing for managing data having an attribute; processing for specifying the data number of data having the attribute at each time of a predetermined time for each attribute with regards to the data; processing for calculating the number of times that the data number of data having one attribute is equal to or greater than the threshold values at a first time and less than the threshold values at a second time in which unit time has passed from the first time to a plurality of threshold values, and calculating a score for each threshold value on the basis of the number of times; processing for specifying an anonymization index from the plurality of threshold values on the basis of the score as one a threshold value specified; and processing for specifying the data having the one attribute and the other attribute as data to be updated to commonized attribute, when the data number of data having one attribute in the managed data is less than the anonymization index and the sum of the number and the data number of data having at least one or more other attributes is equal to or greater than the anonymization index.

### Effect of the Invention

An example of the effect of the present invention is to be able to specify an appropriate index value for guaranteeing anonymity of data, even when the data number of data included in a predetermined group increases and decreases with time.

### BRIEF DESCRIPTION OF THE DRAWINGS

FIG. 1 is a block diagram showing a configuration of an anonymization index determination device according to a first exemplary embodiment of the present invention.

FIG. 2 is a diagram showing an example of data which a data management unit manages.

FIG. 3 is a diagram showing an example of data number of data which the data management unit stores.

FIG. 4 is a diagram showing an example of an abstraction tree.

FIG. 5 is a diagram showing a hardware configuration of the anonymization index determination device according to the first exemplary embodiment and its peripheral devices.

FIG. 6 is a flow chart showing an outline of operation of the anonymization index determination device according to the first exemplary embodiment.

FIG. 7 is a block diagram showing a configuration of an anonymization index determination device according to a first modification of the first exemplary embodiment.

FIG. 8 is a diagram showing an example of information which the data management unit stores.

FIG. 9 is a block diagram showing a configuration of an anonymization index determination device according to the first modification of the first exemplary embodiment.

FIG. 10 is a block diagram showing a configuration of an anonymization processing execution system.

FIG. 11 is a flow chart showing the outline of operation of an anonymization processing execution system according to the first modification of the first exemplary embodiment.

FIG. 12 is a block diagram showing a configuration of an anonymization index determination device according to a second exemplary embodiment.

FIG. 13 is a diagram showing an example of processing of a combination specification unit when a threshold value is k=5 according to the second exemplary embodiment.

FIG. 14 is a diagram showing an example of processing of the combination specification unit when threshold value is k=5 according to the second exemplary embodiment.

FIG. 15 is a flow chart showing the outline of operation of the anonymization index determination device according to the second exemplary embodiment.

FIG. 16 is a block diagram showing a configuration of an anonymization index determination device according to a third exemplary embodiment.

FIG. 17 is a flow chart showing an outline of operation of the anonymization index determination device according to the third exemplary embodiment.

FIG. 18 is a diagram showing an example of operation of a score calculation unit when a threshold value is k=5, the data number of data of an attribute A is 10, and the data number of data of an attribute B is 4 according to the third exemplary embodiment.

### EXEMPLARY EMBODIMENT OF THE INVENTION

Exemplary embodiments of the present invention will be described in detail with reference to drawings. Further, in each drawing and each exemplary embodiment described in a specification, a similar code is given to a component having the similar function, and a repeat of the detailed description may be omitted.

### First Exemplary Embodiment

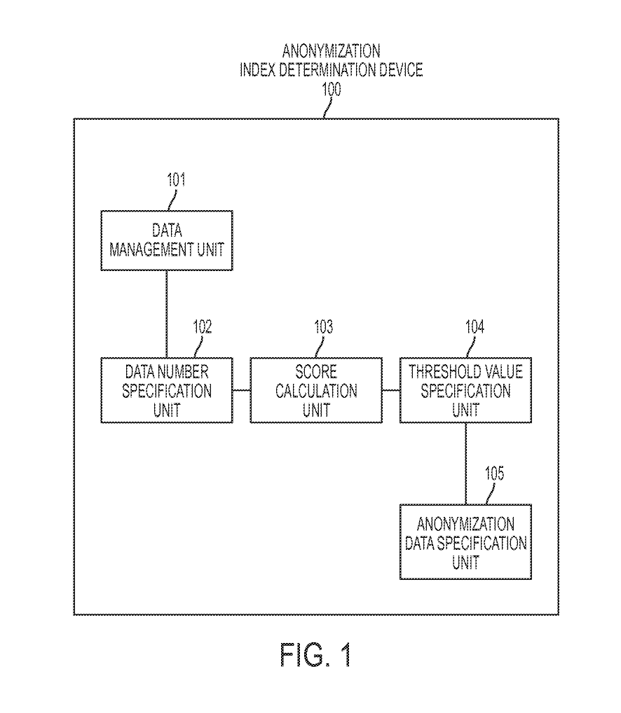

FIG. 1 is a block diagram showing an example of a configuration of an anonymization index determination device 100 according to a first exemplary embodiment of the present invention. Referring to FIG. 1, the anonymization index determination device 100 includes a data management unit 101, a data number specification unit 102, a score calculation unit 103, a threshold value specification unit 104 and an anonymization data specification unit 105.

The anonymization index determination device 100 according to the first exemplary embodiment specifies, for each attribute, the data number of data having the attribute at each time of a predetermined time. Then, the anonymization index determination device 100 calculates, for each of a plurality of threshold values, the number of times which the specified data number is equal to or greater than the threshold value at a first time and is less than the threshold value at a second time in which unit time passes from the first time. Then, the anonymization index determination device 100 calculates a score on the basis of the calculated number of times. Then, the anonymization index determination device 100 specifies an anonymization index which is one threshold value specified on the basis of the calculated score from the plurality of threshold values mentioned above. The anonymization index determination device 100 specifies data having one attribute and other attribute as data to be updated to commonized attribute when the data number of data having a certain attribute (one attribute) is less than this anonymization index and the sum of the data number of data having the attribute (one attribute) and the data number of data having at least one or more of other attributes is equal to or greater than the anonymization index.

As the explanation to here, the anonymization index determination device 100 according to the first exemplary embodiment specifies the anonymization index on the basis of the number of times which the data number increases and decreases to sandwich a certain threshold value. Then, the anonymization index determination device 100 specifies data having one attribute and other attribute as data to be updated to commonized attribute on the basis of the anonymization index.

Therefore, even when the data number of data included in a predetermined group increases and decreases with time, the anonymization index determination device 100 according to the first exemplary embodiment can specify an appropriate index value (anonymization index) for guaranteeing anonymity of the data. Specifically, the anonymization index determination device 100 according to the first exemplary embodiment can specify the anonymization index from the threshold value on the basis of the score which is calculated from the calculated number of times. Then, the anonymization index determination device 100 can specify data having one attribute and other attribute on the basis of the anonymization index as data to be updated to commonized attribute. Accordingly, the anonymization index determination device 100 can take the above-mentioned effect.

Hereinafter, each component which the anonymization index determination device 100 according to the first exemplary embodiment includes will be described.

===Data Management Unit 101===

The data management unit 101 manages data having an attribute.

The attribute is, for example, a quasi-identifier. The quasi-identifiers are information with a fear that an individual is specified when they are combined.

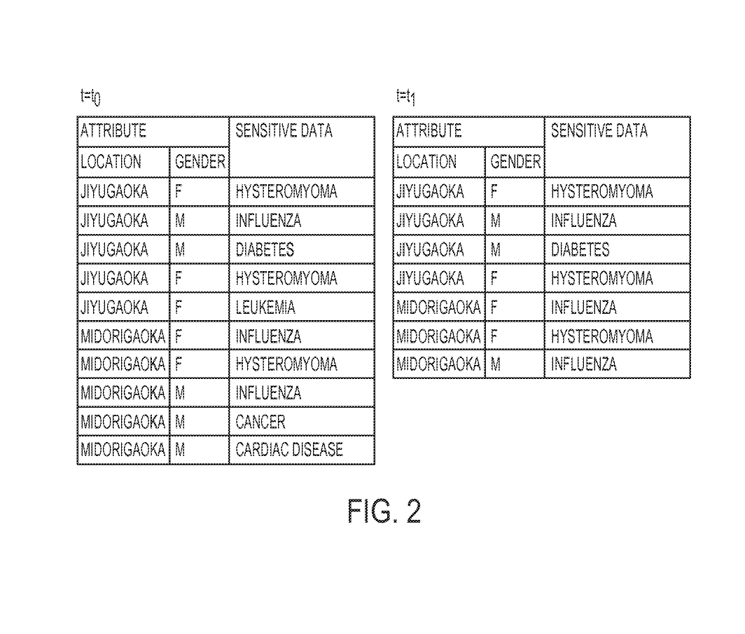

FIG. 2 is a diagram showing an example of data which the data management unit 101 manages. Referring to FIG. 2, the data management unit 101 stores at least one or more kinds of attributes and a sensitive data at each time of a predetermined period (for example, t₀ and t₁) in association with each other. The kinds of attributes shown in FIG. 2 are two kinds of “Residence” and “Gender”. The sensitive data is personal information to which consideration is required for handling in particular. In addition, the sensitive data shown in FIG. 2 is exemplary. An attribute and one or more information should be associated with each other as for a data which the management unit 101 manages.

In the description of this exemplary embodiment below, although it is described as the type of attribute possessed by the data is one (type of attribute “Residence”), this exemplary embodiment is not limited thereto. For example, as shown in FIG. 2, when there is a plurality of types of attributes possessed by the data, the anonymization index determination device 100 of this exemplary embodiment should regard that a group of a value of the attribute of each type is one attribute, and should just process operation of description hereinafter. For example, the anonymization index determination device 100 should regard that a group “Jiyugaoka and Female” of the attribute “Jiyugaoka” of a type of attribute “Residence” and the attribute “Female” of a type of attribute “Gender” is one attribute, and should just process operation of description below.

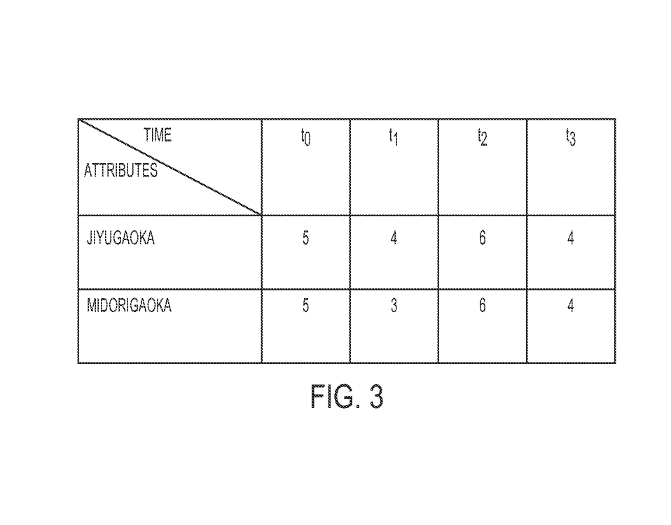

For example, the data management unit 101 may receive information which indicates the data number of data for each attribute from the data number specification unit 102 which will be mentioned later, and store it. FIG. 3 is a diagram showing an example of information which the data management unit 101 receives from the data number specification unit 102. Referring to FIG. 3, the data management unit 101 stores the data number of data which is managed at each time (for example, t₀, t₁, t₂ and t₃) of the predetermined period (for example, between t₀ and t₃) for each attribute.

===Data Number Specification Unit 102===

The data number specification unit 102 specifies “the data number” of data having the attribute in each time of the predetermined time for each attribute possessed by the data, with regards to data which the data management unit 101 manages.

For example, when data shown in FIG. 2 is managed by the data management unit 101, the data number specification unit 102, as shown in FIG. 3, specifies that the data number of data having the attribute “Jiyugaoka” is five, and the data number of data having the attribute “Midorigaoka” is five at time t₀.

===Score Calculation Unit 103===

The score calculation unit 103 calculates the number of times by which a data number of data which the data number specification unit 102 specifies for each attribute is equal to or greater than the threshold value at a first time and is less than the threshold value at a second time in which unit time has passed from the first time to a plurality of threshold values.

A plurality of threshold values, for example, are threshold values which are zero or more and have a different value arbitrarily selected in the range less than the minimum value from which the above-mentioned number of times is zero.

For example, a case in which one threshold value k of a plurality of threshold values is k=5 is considered. And, it is supposed that the data number of data which the data number specification unit 102 specifies for each attribute is the number shown in FIG. 3.

When the time is t₀, both the data number of data having the attribute “Jiyugaoka” and that of “Midorigaoka” are equal to or greater than the threshold value k (=5). That is, the time t₀ corresponds to the first time. Then, when it is the time t₁ in which unit time has passed from the time t₀, both the data number of data having the attribute “Jiyugaoka” and that of “Midorigaoka” are less than the threshold value k (=5). That is, the time t₁ corresponds to the second time in which unit time has passed from the first in time t₀. Similarly, when the time is t₂ (corresponding to the first time), both of the data number of data having the attributes “Jiyugaoka” and that of “Midorigaoka” are equal to or greater than the threshold value k (=5). Then, when it is the time t₃ (corresponding to the second time in which unit time has passed from the first time), both the data number of data having the attribute “Jiyugaoka” and that of “Midorigaoka” are less than the threshold value k (=5).

Accordingly, in this case, the score calculation unit 103 calculates the above-mentioned number of times as two times. Further, the score calculation unit 103 may calculate the number of times for each attribute and sum them. For example, in case of the number shown in FIG. 3, the score calculation unit 103 may calculate the above-mentioned number of times as 4 times.

Similarly, when the threshold value k is k=6, the score calculation unit 103 calculates the above-mentioned number of times as one time. Then, when the threshold value k is k=7, the score calculation unit 103 calculates the above-mentioned number of times as 0 times.

Moreover, the score calculation unit 103 calculates a score on the basis of the above-mentioned number of times. This score is a value used to specify an anonymization index mentioned later.

The calculation method of the score that the score calculation unit 103 of this exemplary embodiment uses is not limited in particular, and various calculation methods can be used.

For example, the score calculation unit 103 may calculate the score Sc(k) on the basis of the calculation method shown by the next [Equation 1].

$$Sc ( k ) = \{ \begin{matrix}\frac{1}{n ( k )} & ( n ( k ) \neq 0 ) \\ 0 & ( n ( k ) = 0 )\end{matrix} \qquad [ Equation 1 ]$$

In [Equation 1], n(k) is the above-mentioned number of times that the score calculation unit 103 calculates when the threshold value is k.

When data has a plurality of types of attributes, the score calculation unit 103 may calculate the score for each type of attribute for each threshold value, and sum the calculated scores. For example, the score calculation unit 103 may sum the score in the type of each attribute for each threshold value on the basis of the calculation method shown by [Equation 2].

$$Sc ( k ) = {\sum }_{type ∈ X} {Sc}_{type} ( k ) \qquad [ Equation 2 ]$$

In [Equation 2], X is a set of types of attributes, and type is a type of attribute. And, Sc_{type}(k) is the score for the type of attribute “type” and the threshold value k. Sc(k) is the score which the score calculation unit 103 calculates for each attribute.

===Threshold Value Specification Unit 104===

The threshold value specification unit 104 specifies an anonymization index which is one threshold value specified on the basis of the score that the score calculation unit 103 calculated from a plurality of threshold values which the score calculation unit 103 used.

For example, when the score Sc(k) can be acquired using the above-mentioned [Equation 1], the threshold value specification unit 104 may specify the threshold value k where the calculated score Sc(k) becomes the minimum except for 0 as an anonymization index. Further, when there is a plurality of threshold value k where the calculated score Sc(k) becomes the minimum, the threshold value specification unit 104 may specify any one of the threshold value k. However, as an example, the threshold value specification unit 104 of this exemplary embodiment specifies the minimum k in a plurality of threshold values whose scores Sc(k) are the minimum as an anonymization index.

And, when the score is calculated by other methods, the threshold value specification unit 104 may specify the threshold value k where the calculated score Sc(k) becomes the maximum as an anonymization index. When there is a plurality of threshold value k where the calculated score Sc(k) becomes the maximum, the threshold value specification unit 104 should specify the threshold value k (for example, the minimum k or the maximum k) according to a predetermined regulation from a plurality of threshold values like the above mentioned description, as an anonymization index.

===Anonymization Data Specification Unit 105===

The anonymization data specification unit 105 judges the following two conditions about data which the data management unit 101 manages. The first condition is that the data number of data having one attribute is less than an anonymization index which the threshold value specification unit 104 specifies. The second condition is that the sum of the data number of data having above-mentioned one attribute and the data number of data having at least one or more of other attributes is equal to or greater than the above-mentioned anonymization index. In this specification, the above-mentioned “one attribute” that satisfies these two conditions is also called a “target attribute”.

The anonymization data specification unit 105 specifies data having the above-mentioned target attribute (one attribute) that satisfies the above-mentioned two conditions and the above-mentioned other attributes as data to be updated to commonized attributes. When there are plural target attributes which satisfy the above-mentioned two conditions, the anonymization data specification unit 105 may specify data corresponding to each target attribute and data having other attributes respectively as data to be updated to commonized attributes.

For example, it is supposed that a target attribute “Midorigaoka” and other attribute “Jiyugaoka”, and, a target attribute “Toyama” and other attribute “Okubo”, respectively, satisfy the above-mentioned two conditions. In this case, the anonymization data specification unit 105 specifies data to be updated to commonized attributes as follows.

First, the anonymization data specification unit 105 specifies data having the attribute “Midorigaoka” and the attribute “Jiyugaoka” as data to be updated to one commonized attribute (for example, the attribute “Meguro-ku” which indicates a superordinate concept of the attribute “Midorigaoka” and the attribute “Jiyugaoka”). And, the anonymization data specification unit 105 specifies data having the attribute “Toyama” and the attributes “Okubo” as data to be updated to one commonized attribute (for example, the attribute “Shinjuku-ku” which shows a superordinate concept of the attribute “Toyama” and the attribute “Okubo”).

And, the anonymization data specification unit 105 may specify other attributes on the basis of information which shows a relation between attributes. The information which shows a relation between attributes is not limited in particular. For example, the anonymization data specification unit 105 may use an abstraction tree. When an abstraction tree is used, for example, the anonymization data specification unit 105 may operate as follows.

Firstly, the anonymization data specification unit 105 specifies one attribute on the basis of the first above-mentioned condition.

Secondly, the anonymization data specification unit 105 specifies a candidate of the other attributes on the basis of an abstraction tree.

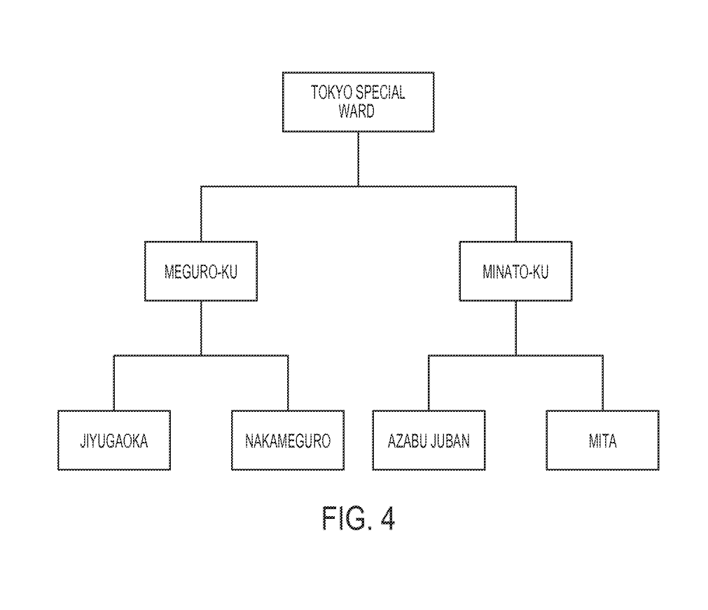

Further, the abstraction tree is information equipped with a tree structure which shows a hierarchical relation between attributes. FIG. 4 is a diagram showing an example of an abstraction tree. Referring to FIG. 4, the attribute “Meguro-ku” is a superordinate concept of the attributes “Jiyugaoka” and “Nakameguro”. Therefore, when the attribute “Jiyugaoka” is specified as one attribute, the anonymization data specification unit 105 specifies the attribute “Nakameguro” whose common superordinate concept with the attribute “Jiyugaoka” is the superordinate concept “Meguro-ku” as a candidate of other attribute. Further, the other attribute is one for an example shown in FIG. 4. Therefore, the anonymization data specification unit 105 specifies the attribute “Nakameguro” as a candidate of the other attribute, However, when a plurality of attributes are specified, the anonymization data specification unit 105 may specify a plurality of specified attributes as candidates of the other attributes.

Information (for example, abstraction tree) which shows a relation between attributes may be stored in the anonymization data specification unit 105 or may be stored in other component.

Thirdly, the anonymization data specification unit 105 judges whether or not each candidate of the other attributes satisfies the above-mentioned second condition to the above-mentioned one attribute. Then, the anonymization data specification unit 105 specifies the other attribute which satisfies the second condition among candidates of the above-mentioned other attributes on the basis of the judgment. For example, in case of the example of FIG. 4, when one attribute is assumed to be the attribute “Jiyugaoka”, other attribute may be specified as “Nakameguro”.

Fourthly, the anonymization data specification unit 105 specifies data having the above-mentioned one attribute and the other attribute specified in the third processing as data to be updated to commonized attribute. The commonized attribute is an attribute which shows a superordinate concept commonized to each attribute, for example. In case of the example of FIG. 4, the anonymization data specification unit 105 specifies data having the attributes “Jiyugaoka” and “Nakameguro” as data to be updated to the attribute “Meguro-ku”. Further, when a hierarchical relation exists between the one attribute and the other attribute specified in the third processing, the commonized attribute may be the attribute which shows a superordinate concept in each above-mentioned attribute. For example, when the one attribute shown in FIG. 4 is the attribute “Jiyugaoka” and the other attribute is “Meguro-ku”, the anonymization data specification unit 105 may specify data having the attributes “Jiyugaoka” and “Meguro-ku” as data to be updated to the attribute “Meguro-ku”.

When the data which the anonymization data specification unit 105 specifies are updated to the commonized attribute, data which the data management unit 101 manages are secured by k-anonymity if the anonymization index is set to k.

The k-anonymity is a characteristic which guarantees that a certain data cannot be distinguished from at least other k−1 data. That is, when the k-anonymity is satisfied, data having the same quasi-identifier (attribute) exists k or more.

On the basis of the processing of the above mentioned description, the anonymization data specification unit 105 specifies data of a target of anonymization processing for guaranteeing k-anonymity.

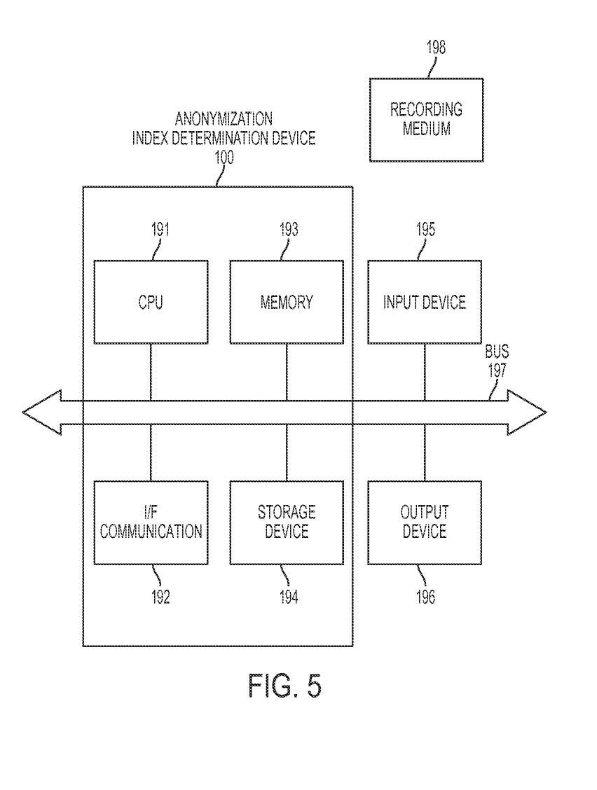

FIG. 5 is a diagram showing an example of a hardware configuration of the anonymization index determination device 100 according to the first exemplary embodiment of the present invention, and its peripheral devices. As shown in FIG. 5, the anonymization index determination device 100 includes a CPU 191 (Central Processing Unit 191), a communication I/F 192 (communication interface 192) for network connections, a memory 193 and a storage device 194 such as a hard disk which stores a program. And, the anonymization index determination device 100 connects with an input device 195 and an output device 196 via a bus 197.

The CPU 191 operates an operating system and controls the whole anonymization index determination device 100 according to the first exemplary embodiment of the present invention. And, for example, the CPU 191 reads a program and data from a recording medium 198 which is not shown and is installed in a drive device which is not shown to the memory 193. Then, the CPU 191 executes each kind of processes according to this program as the data management unit 101, the data number specification unit 102, the score calculation unit 103, the threshold value specification unit 104 and the anonymization data specification unit 105 according to the first exemplary embodiment.

The storage device 194 is, for example, an optical disk, a flexible disk, a magnetic optical disk, an external hard disk or a semiconductor memory, and records a computer program so that it is computer-readable. And, the computer program may be downloaded from an external computer which is not shown and is connected to a communication network. The data management unit 101 may be realized using the storage device 194.

The input device 195 is, for example, realized by a mouse and a keyboard, or a built-in key button, and is used for an input operation. The input device 195 may not be limited to a mouse and a keyboard, or a built-in key button, but be a touch panel, an accelerometer, a gyro sensor or a camera, for example.

For example, the output device 196 is realized by a display and is used to confirm an output.

Further, a block diagram (FIG. 1) used in a description of the first exemplary embodiment does not show a configuration of hardware units but shows blocks of functional units. These function blocks are realized using a hardware configuration shown in FIG. 5. However, a realization means of each unit which the anonymization index determination device 100 includes is not limited in particular. Namely, the anonymization index determination device 100 may be realized using one device coupled physically, or may be realized connecting two or more devices which are separated physically by a wire or a wireless and using these plural devices.

And, the CPU 191 may read a computer program recorded in the storage device 194 and operate according to the program as the data management unit 101, the data number specification unit 102, the score calculation unit 103, the threshold value specification unit 104 and the anonymization data specification unit 105.

And, although it is already described, the recording medium 198 (or other storage media) which is not shown and records the code of the above-mentioned program is supplied to the anonymization index determination device 100, and the anonymization index determination device 100 may read and execute the code of the program stored in the recording medium 198. That is, the present invention also includes the recording medium 198 which is not shown, and stores software (anonymization index determination program), which the anonymization index determination device 100 according to the first exemplary embodiment executes, transitorily or non-transitorily.

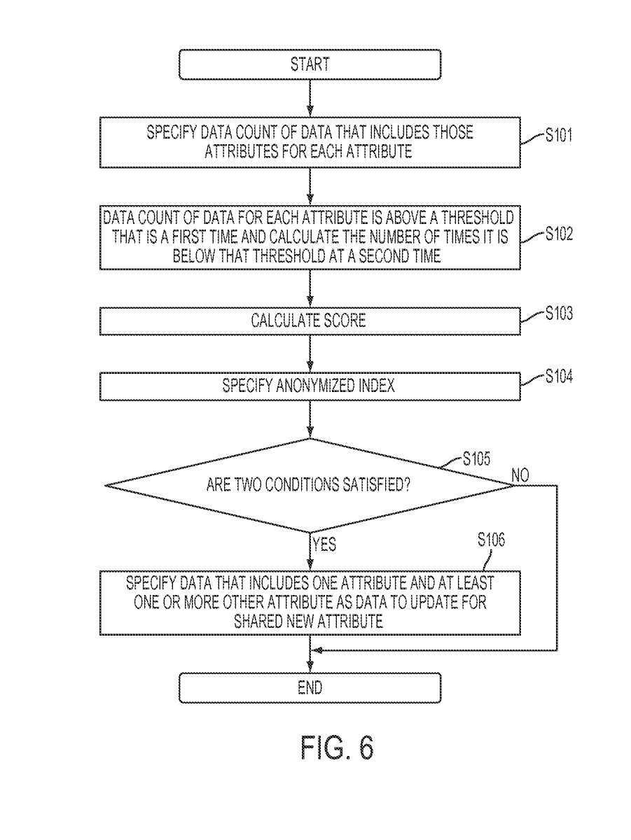

FIG. 6 is a flow chart showing an outline of operation of the anonymization index determination device 100 according to the first exemplary embodiment.

The data number specification unit 102 specifies the data number of data having the attribute for each attribute, with regards to data which the data management unit 101 manages (Step S101).

The score calculation unit 103 calculates the number of times that the data number of data having a certain attribute which the data number specification unit 102 specifies is equal to or greater than a certain threshold value at a first time, and is less than the threshold value at a second time in which unit time has passed from the first time to a plurality of threshold values (Step S102).

The score calculation unit 103 calculates a score for each threshold value on the basis of the calculated number of times (Step S103).

The threshold value specification unit 104 specifies an anonymization index which is one threshold value specified on the basis of the calculated score from a plurality of above-mentioned threshold values (Step S104).

The anonymization data specification unit 105 judges the following two conditions about data which the data management unit 101 manages (Step S105). The first condition is that the data number of data having one certain attribute is less than the anonymization index specified at Step S104. The second condition is that the sum of the data number of data having the above-mentioned one attribute and the data number of data having at least one or more of the other attributes is equal to or greater than the above-mentioned anonymization index.

When the anonymization data specification unit 105 judges that the above-mentioned two conditions are satisfied (“Yes” of Step S105), the anonymization data specification unit 105 specifies data having the above-mentioned one attribute and at least one or more of the above-mentioned other attributes as data to be updated to commonized attributes, (Step S106). When a plurality of data of the one attribute are specified, the anonymization data specification unit 105 specifies data having the one attribute and at least one or more of the other attributes as data to be updated to certain commonized attributes for each attribute. Then, the processing by the anonymization index determination device 100 ends.

On the other hand, when the anonymization data specification unit 105 judges that the above-mentioned two conditions are not satisfied about data which the data management unit 101 manages (“No” of Step S105), processing of the anonymization index determination device 100 ends.

The anonymization index determination device 100 according to the first exemplary embodiment specifies the data number of data having the attribute at each time of a predetermined time for each attribute. Then, the anonymization index determination device 100 calculates the number of times by which the specified data number is equal to or greater than a certain threshold value at a first time, and is less than the threshold value at a second time in which unit time has passed from the first time to a plurality of threshold values. Then, the anonymization index determination device 100 calculates the score on the basis of the calculated number of times. Then, the anonymization index determination device 100 specifies the anonymization index which is one threshold value specified on the basis of the calculated score from a plurality of above-mentioned threshold values. The anonymization index determination device 100 judges whether or not the data number of data having one attribute is less than the anonymization index, and the sum of the data number of data having the one attribute and the data number of data having at least one or more of other attributes is equal to or greater than the anonymization index (whether or not it is a target attribute). Then, the anonymization index determination device 100 specifies data having the target attribute and other attributes as data to be updated to commonized attributes.

As described above, the anonymization index determination device 100 according to the first exemplary embodiment specifies the anonymization index on the basis of the number of times that the data number increased and decreased to sandwich a certain threshold value. Then, the anonymization index determination device 100 specifies data having one attribute and other attributes on the basis of the anonymization index as data to be updated to commonized attributes.

Therefore, even when the data number of data included in a predetermined group increases and decreases with time, the anonymization index determination device 100 according to the first exemplary embodiment can specify an appropriate index value (anonymization index) for guaranteeing anonymity of the data. Specifically, the anonymization index determination device 100 according to the first exemplary embodiment can specify the anonymization index from a threshold value on the basis of the score calculated from (the number of times). Then, the anonymization index determination device 100 can specify data having one attribute and other attributes on the basis of the anonymization index as data to be updated to commonized attributes. Accordingly, the anonymization index determination device 100 can take the above-mentioned effect.

### First Modification of First Exemplary Embodiment

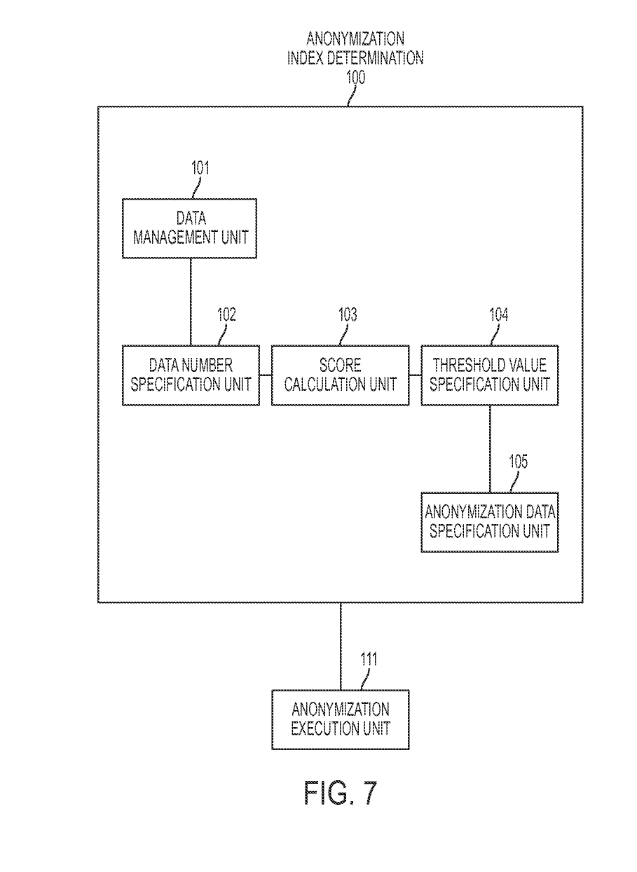

In the first exemplary embodiment, the anonymization index determination device 100 may be connected with an anonymization execution unit 111 which anonymizes the data which the anonymization data specification unit 105 specifies. FIG. 7 is a block diagram showing an example of a configuration of the anonymization index determination device 100 and an anonymization execution unit 111 according to the first modification of the first exemplary embodiment.

===Anonymization Execution Unit 111===

The anonymization execution unit 111 anonymizes the data which the anonymization data specification unit 105 specifies. Specifically, the anonymization execution unit 111 updates applicable attributes possessed by the data specified by the anonymization data specification unit 105 to commonized attributes.

For example, an anonymization execution unit 111 may update the applicable attributes to an attribute which shows a superordinate concept which is commonized to the applicable attributes possessed by the data which the anonymization data specification unit 105 specifies. The anonymization execution unit 111 may receive information which shows a commonized attribute from the anonymization data specification unit 105. Or, the anonymization execution unit 111 stores an abstraction tree shown in FIG. 4, and may specify a commonized attribute based on the abstraction tree.

The anonymization execution unit 111 may update above-mentioned all of data having the one attribute and all of data having the above-mentioned other attributes corresponding to the one attribute to commonized attributes. Such anonymization method is called “global recoding”.

And, the anonymization execution unit 111 may update all of data having the above-mentioned one attribute and the part of the data having the above-mentioned other attributes corresponding to the one attribute to commonized attributes. Such anonymization method is called “local recoding”. When local recoding is applied, in data having the above-mentioned other attributes, the data number of data whose attribute is updated is a difference value of the anonymization index which the threshold value specification unit 104 specifies and the data number of data having the above-mentioned one attribute. When local recoding is applied, the data number of anonymized data is less than that of a case of global recoding. Therefore, a loss of the amount of information in local recoding is smaller than a loss of the amount of information in global recoding.

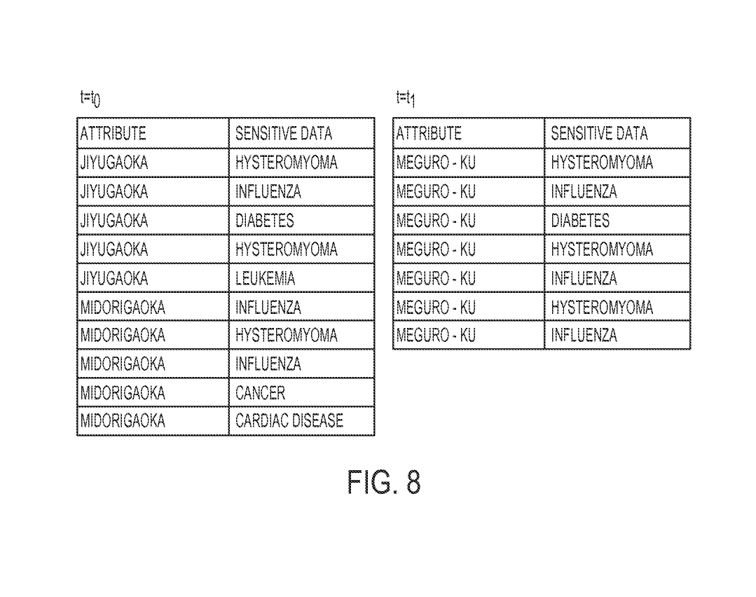

In the first modification of the first exemplary embodiment, the data management unit 101 may store data which the anonymization execution unit 111 anonymizes. FIG. 8 is a diagram showing an example of information which the data management unit 101 stores. Referring to FIG. 8, at the time t₁, all data are anonymized. That is, the attributes “Jiyugaoka” and “Midorigaoka” possessed by each data at the time t₁ are updated to “Meguro-ku”.

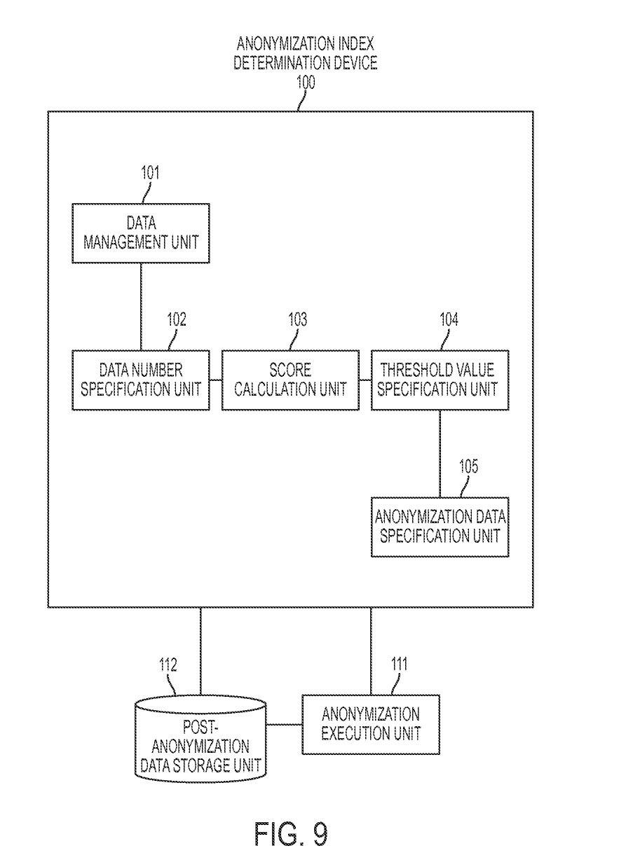

In the first modification of the first exemplary embodiment, the anonymization index determination device 100 may be connected with a post-anonymization data storage unit 112 which stores the data which the anonymization execution unit 111 anonymizes. FIG. 9 is a block diagram showing an example of a configuration of the anonymization index determination device 100, the anonymization execution unit 111 and a post-anonymization data storage unit 112 according to the first modification of the first exemplary embodiment.

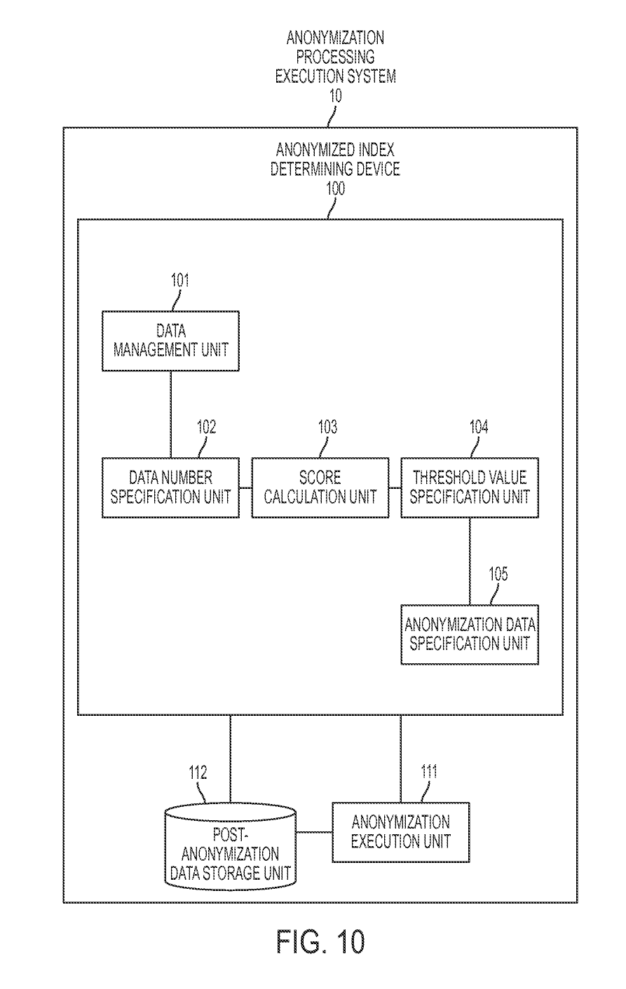

Further, in the first exemplary embodiment, the anonymization index determination device 100 may include the anonymization execution unit 111 and the post-anonymization data storage unit 112. FIG. 10 is a block diagram showing an example of a configuration of the anonymization processing execution system 10 including the anonymization index determination device 100, the anonymization execution unit 111 and the post-anonymization data storage unit 112.

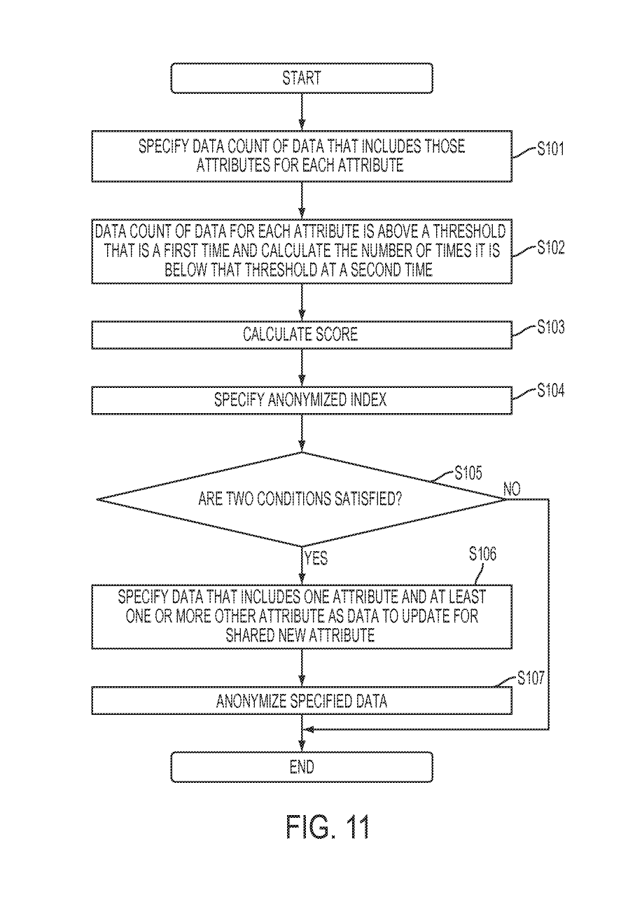

FIG. 11 is a flow chart showing an outline of operation of the anonymization processing execution system 10 according to the first modification of the first exemplary embodiment.

In data which the data management unit 101 manages, the data number specification unit 102 specifies a data number of data having the attribute for each attribute (Step S101).

The score calculation unit 103 calculates the number of times that the data number of data having a certain attribute which the data number specification unit 102 specified is equal to or greater than a certain threshold value at a first time, and is less than the threshold value at a second time in which unit time has passed from the first time to a plurality of threshold values (Step S102).

The score calculation unit 103 calculates a score for each threshold value on the basis of the calculated number of times (Step S103).

The threshold value specification unit 104 specifies an anonymization index which is one threshold value specified on the basis of the calculated score from a plurality of above-mentioned threshold values (Step S104).

In data which the data management unit 101 manages, the anonymization data specification unit 105 judges the following two conditions (Step S105). The first condition is that the data number of data having one certain attribute is less than the anonymization index specified at Step S104. The second condition is that the sum of the data number of data having the above-mentioned one attribute and the data number of data having at least one or more of the other attributes is equal to or greater than the above-mentioned anonymization index. That is, the anonymization data specification unit 105 judges one attribute which becomes a target attribute.

When the anonymization data specification unit 105 judges that the above-mentioned two conditions are not satisfied about the data which the data management unit 101 manages (“No” of Step S105), the processing by the anonymization processing execution system 10 ends.

On the other hand, when it is judged that the above-mentioned two conditions are satisfied (“Yes” of Step S105), the anonymization data specification unit 105 specifies data having the above-mentioned target attribute and at least one or more of the above-mentioned other attributes as data to be updated to commonized attributes (Step S106). When plural target attributes are specified, the anonymization data specification unit 105 specifies data having the target attributes and at least one or more of other attributes as data to be updated to certain commonized attributes for each target attribute.

The anonymization execution unit 111 anonymizes data which the anonymization data specification unit 105 specifies (Step S107). Then, processing of the anonymization processing execution system 10 ends.

The anonymization index determination device 100 and the anonymization processing execution system 10 according to the first modification of the first exemplary embodiment specify the data number of data having the attribute for each attribute at each time of a predetermined time. Then, the anonymization index determination device 100 and the anonymization processing execution system 10 calculate the number of times that the data number specified is equal to or greater than a certain threshold value at a first time, and is less than the threshold value at a second time in which unit time has passed from the first time to plural threshold values. Then, the anonymization index determination device 100 and the anonymization processing execution system 10 calculate a score on the basis of the calculated number of times. Then, the anonymization index determination device 100 and the anonymization processing execution system 10 specify an anonymization index which is one threshold value specified on the basis of the calculated score from a plurality of above-mentioned threshold values. When the data number of data having one certain attribute is less than this anonymization index, and the sum of the data number of data having the one attributes and the data number of data having at least one or more of the other attributes is equal to or greater than the anonymization index, the anonymization index determination device 100 and the anonymization processing execution system 10 specify the data having the one attribute (target attribute) and the other attributes as data to be updated to commonized attributes. The anonymization execution unit 111 updates the specified data to a commonized attribute.

That is, the anonymization index determination device 100 and the anonymization processing execution system 10 according to the first modification of the first exemplary embodiment specify the anonymization index on the basis of the number of times that the data number increased and decreased to sandwich a certain threshold value, and anonymize on the basis of the anonymization index. Therefore, even when the data number of data included in a predetermined group increases and decreases with time, the anonymization index determination device 100 and the anonymization processing execution system 10 according to the first modification of the first exemplary embodiment can guarantee anonymity of the data.

### Second Modification of First Exemplary Embodiment

In the first exemplary embodiment, the score calculation unit 103 may receive the anonymization index which the threshold value specification unit 104 specifies. Then, when the above-mentioned score of the anonymization index is equal to or greater than a predetermined value, the score calculation unit 103 may calculate the score respectively to a plurality of threshold values including the anonymization index.

This predetermined value is a value which shows that anonymity cannot be guaranteed at least. If behavior that a certain predetermined attribute is anonymized or not anonymized in the predetermined number of times is made, even if the attribute is anonymized, a possibility of being analogized on the basis of information on a non-anonymized time will increase. This predetermined value shows a threshold value of whether or not this analogized possibility loses anonymity of data.

The anonymization index determination device 100 according to the second modification of the first exemplary embodiment specifies a new anonymization index when it is judged that anonymity cannot be guaranteed based on an original anonymization index. Accordingly, even when the data number of data included in a predetermined group increases and decreases with time, the anonymization index determination device 100 of this modification can specify an appropriate index value for guaranteeing anonymity of the data. Then, when anonymity cannot be guaranteed, the anonymization index determination device 100 according to this modification specifies a new anonymization index. Therefore, the anonymization index determination device 100 according to this modification takes the effect that an unnecessary processing load in a time of anonymity originally being guaranteed can be reduced.

### Second Exemplary Embodiment

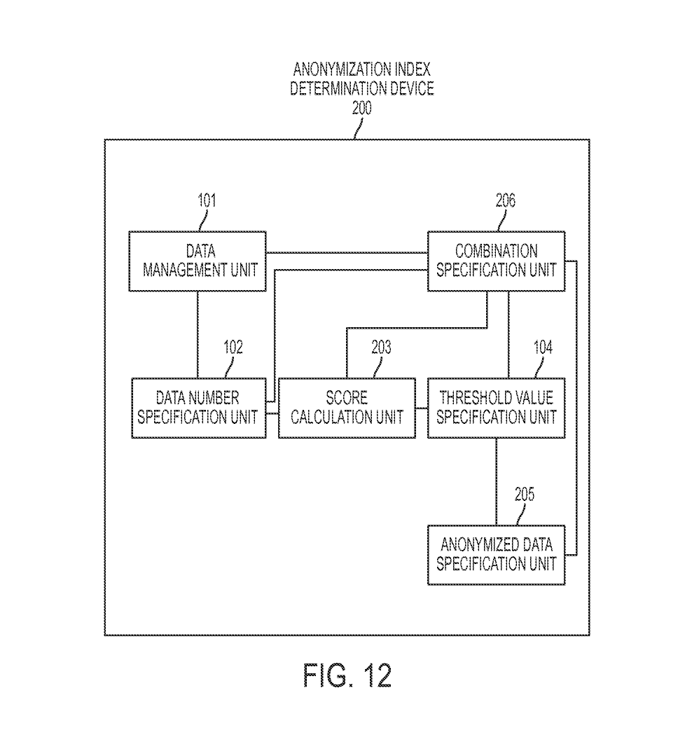

FIG. 12 is a block diagram showing an example of a configuration of an anonymization index determination device 200 according to a second exemplary embodiment. Referring to FIG. 12, the anonymization index determination device 200 according to the second exemplary embodiment includes the data management unit 101, the data number specification unit 102, a score calculation unit 203, the threshold value specification unit 104, an anonymization data specification unit 205 and a combination specification unit 206.

The anonymization index determination device 200 according to the second exemplary embodiment specifies combination of attributes by which the data number of data having a certain attributes or the sum of the data number of data having any one of a plurality of attributes becomes equal to or greater than a threshold value. Then, the anonymization index determination device 200 specifies the sum of the data number of data having each attribute included in a combination including a predetermined attribute from the specified combinations. The anonymization index determination device 200 acquires (calculates) a rate of change from value of the first time to value of the second time of a ratio that the data number of data having the predetermined attribute occupies in the sum for each attribute. The anonymization index determination device 200 calculates a score for specifying an anonymization index on the basis of the acquired rate of change.

Here, the calculated rate of change shows a probability that pre-anonymization data is performed will be analogized from a post-anonymization data.

That is, a data with a large rate of change has a large change of ratio between the attributes of the data number before and after anonymization processing. Accordingly, the data with a large rate of change has a small probability that the pre-anonymization data is analogized. On the other hand, a data with a small rate of change has a small change of ratio between the attributes of the data number before and after anonymization processing. Accordingly, the data with a small rate of change has a large probability that the pre-anonymization data is analogized.

The anonymization index determination device 200 according to the second exemplary embodiment calculates a score for specifying an anonymization index on the basis of a probability that a pre-anonymization data will be analogized. Therefore, the anonymization index determination device 200 can specify an appropriate index value for guaranteeing anonymity of the data, even when the data number of data included in a predetermined group increases and decreases with time, and a possibility which the pre-anonymization data will be analogized is high.

Hereinafter, each component which the anonymization index determination device 200 according to the second exemplary embodiment includes will be described.

===Score Calculation Unit 203===

When the data number of data having one attribute which the data number specification unit 102 specifies is equal to or greater than a certain threshold value at a first time, and is less than the threshold value at a second time in which unit time has passed from the first time to a plurality of threshold values, the score calculation unit 203 executes the following processing. Here, in this specification, “one attribute” which satisfies the above-mentioned two conditions is also called a “calculation target attribute”.

The score calculation unit 203 specifies a combination including the above-mentioned calculation target attribute from the combinations which a combination specification unit 206 mentioned later specifies. Then, the score calculation unit 203 acquires a rate of change from a value at the first time to a value at the second time in which unit time has passed of a ratio that the data number of data including the calculation target attribute occupies in the sum of the data number of data having each attribute included in the combination for each attribute included in the specified combination.

Hereinafter, it will be described with reference to FIG. 3. Here, the threshold value k is supposed k=5. When k=5 is supposed, the attributes “Jiyugaoka” and “Midorigaoka” for which the second time is set to t₁ and the attributes “Jiyugaoka” and “Midorigaoka” for which the second time is set to t₃ correspond to the calculation target attributes. Then, the combination including these calculation target attributes is supposed the attribute “Jiyugaoka”+“Midorigaoka”. Hereinafter, this combination is also called the “combination “Jiyugaoka”+“Midorigaoka””.

The score calculation unit 203 calculates the ratio P₀ that the data number of data including the calculation target attribute occupies in the sum of the data number of data having each attribute included in the combination “Jiyugaoka”+“Midorigaoka” at the first time. For example, when the first time is t0, the sum of the data number of data having each attribute included in the combination “Jiyugaoka”+“Midorigaoka” is 10. Then, at the time t₀, the ratio that the data number of data including the attribute “Jiyugaoka” occupies in the above-mentioned sum is 5/10=½. And, when the first time is t₀, the ratio that the data number of data including the attribute “Midorigaoka” occupies in the above-mentioned sum is 5/10=½.

Next, the score calculation unit 203 calculates the ratio P₁ that the data number of data including the calculation target attribute occupies in the sum of the data number of data having each attribute included in the combination “Jiyugaoka”+“Midorigaoka” at a second time. For example, when the second time is t₁, the sum of the data number of data having each attribute included in the combination “Jiyugaoka”+“Midorigaoka” is 7. Then, at the time t₁, the ratio that the data number of data including the attribute “Jiyugaoka” occupies in the above-mentioned sum is 4/7. And, when the second time is t₁, the ratio that the data number of data including the attribute “Midorigaoka” occupies in the above-mentioned sum is 3/7.

Next, the score calculation unit 203 calculates the rate of change SPₖ(attr, t) on the basis of the above-mentioned ratio P₀ and P₁. Here, k is a threshold value, attr is a calculation target attribute, and t is the second time. Specifically, the score calculation unit 203 calculates the rate of change SPₖ(attr,t) using the calculation method shown by [Equation 3].

$${SP}_{k} ( attr , t ) = \frac{\vert {P}_{1} - {P}_{0} \vert}{{P}_{1}} \qquad [ Equation 3 ]$$

In case of the above-mentioned example, as shown in [Equation 4], the rate of change SP₅(Jiyugaoka, t₁) about the calculation target attribute “Jiyugaoka” is calculated as SP=1/8.

$$\begin{matrix}{SP}_{5} ( Jiyugaoka , {t}_{1} ) = \frac{\vert {P}_{1} - {P}_{0} \vert}{{P}_{1}} \\ = \frac{\vert \frac{4}{7} - \frac{5}{10} \vert}{\frac{4}{7}} \\ = \frac{1}{8} ( = 0.125 )\end{matrix} \qquad [ Equation 4 ]$$

And, in case of the above-mentioned example, as shown by [Equation 5], the rate of change SP₅(Midorigaoka, t₁) about the calculation target attribute “Midorigaoka” is calculated as SP=1/6.

$$\begin{matrix}{SP}_{5} ( Midorigaoka , {t}_{1} ) = \frac{\vert {P}_{1} - {P}_{0} \vert}{{P}_{1}} \\ = \frac{\vert \frac{3}{7} - \frac{5}{10} \vert}{\frac{3}{7}} \\ = \frac{1}{6} ( \approx 0.167 )\end{matrix} \qquad [ Equation 5 ]$$

The rate of change SPₖ(attr, t) in a case where the first time is t₂ is calculated as shown by the following [Equation 6].

$$\begin{matrix}\begin{matrix}{SP}_{5} ( Jiugaoka , {t}_{3} ) = \frac{\vert {P}_{1} - {P}_{0} \vert}{{P}_{1}} \\ = \frac{\vert \frac{4}{8} - \frac{6}{12} \vert}{\frac{4}{8}} \\ = 0\end{matrix} & [ Equation 6 ] \\ \begin{matrix}{SP}_{5} ( Midorigaoka , {t}_{3} ) = \frac{\vert {P}_{1} - {P}_{0} \vert}{{P}_{1}} \\ = \frac{\vert \frac{4}{8} - \frac{6}{12} \vert}{\frac{4}{8}} \\ = 0\end{matrix} & \end{matrix}$$

The score calculation unit 203 calculates a score S_{c}(k) on the basis of the following method shown below by [Equation 7] for each threshold value using the above-mentioned rate of change SPₖ(attr, t). A is a set of attributes included in the combination including the calculation target attribute in [Equation 7]. attr is an attribute included in the above-mentioned combination. In the present case, attr(s) are “Jiyugaoka” and “Midorigaoka”. And, T′ is a set including a time which corresponds to a “second time” in a predetermined time. In the present case, T′ includes time t₁ and t₃. t is each time included in T′, that is, time t₁ or t₃. Further, a value calculated using [Equation 7] is also called “Privacy Loss” in this specification. Then, the applicable value is also transcribed as PL(k).

$$\begin{matrix}Sc ( k ) = {\sum }_{t ∈ {T}^{′}}^{ } \frac{1}{( \frac{1}{\vert A \vert} {\sum }_{attr ∈ A}^{ } {SP}_{k} ( attr , t ) ) + 1} \\ = PL ( k )\end{matrix} \qquad [ Equation 7 ]$$

According to [Equation 7], the score S_{c}(k) is calculated on the basis of the sum of reciprocal numbers of a value that is added 1 to the average between the calculation target attributes of rate of change SPₖ(attr, t) at the “second time” between predetermined time.

In case of the above-mentioned example, the score calculation unit 203 calculates the score S_{c}(5)=103/55 (=1.87 . . . ) as shown by [Equation 8].

$$\begin{matrix}Sc ( 5 ) = {\sum }_{t ∈ {T}^{′}}^{ } \frac{1}{( \frac{1}{\vert A \vert} {\sum }_{attr ∈ A}^{ } {SP}_{5} ( attr , t ) ) + 1} \\ = \frac{1}{\frac{1}{2} ( \begin{matrix}{SP}_{5} ( Jiyugaoka , {t}_{1} ) + \\ {SP}_{5} ( Midogigaoka , {t}_{1} )\end{matrix} ) + 1} + \\ \frac{1}{\frac{1}{2} ( \begin{matrix}{SP}_{5} ( Jiyugaoka , {t}_{3} ) + \\ {SP}_{5} ( Midorigaoka , {t}_{3} )\end{matrix} ) + 1} \\ = \frac{1}{\frac{1}{2} ( \frac{1}{8} + \frac{1}{6} ) + 1} + \frac{1}{0 + 1} \\ = \frac{48}{55} + 1 = \frac{103}{55} ( = 1.87 … )\end{matrix} \qquad [ Equation 8 ]$$

When the threshold value k is k=6 in FIG. 3, the score is calculated as follows.

In case of k=6, the attributes “Jiyugaoka” and “Midorigaoka” which set the second time to t₃ correspond to the calculation target attributes.

First, the score calculation unit 203 calculates the ratio P₀ that the data number of data including the calculation target attribute occupies in the sum of the data number of data having each attribute included in the combination “Jiyugaoka”+“Midorigaoka” at the first time.

When the first time is t₂, the sum of the data number of data having each attribute included in the combination “Jiyugaoka”+“Midorigaoka” is 12. Then, at t₂, the ratio that the data number of data including the attribute “Jiyugaoka” occupies in the above-mentioned sum is 6/12=½. And, when the first time is t₂, the ratio that the data number of data including the attribute “Midorigaoka” occupies in the above-mentioned sum is 6/12=½.

Next, the score calculation unit 203 calculates the ratio P₁ that the data number of data including the calculation target attribute occupies in the sum of the data number of data having each attribute included in the combination “Jiyugaoka”+“Midorigaoka” at the second time.

When the second time is t₃, the sum of the data number of data having each attribute included in the combination “Jiyugaoka”+“Midorigaoka” is 8. Then, at t₃, the ratio that the data number of data including the attribute “Jiyugaoka” occupies in the above-mentioned sum is 4/8=½. And, when the second time is t₃, the ratio that the data number of data including the attribute “Midorigaoka” occupies in the above-mentioned sum is 4/8=½.

Then, the score calculation unit 203 calculates the rate of change SP₆(attr, t₃) on the basis of the above-mentioned ratios P₀ and P₁. In case of k=6, both of P₀ and P₁ are ½. Accordingly, the rate of change is SP₆(attr, t₃)=0. Consequently, the score calculation unit 203 calculates the score of the threshold value k=6 using the following method shown by [Equation 9].

$$\begin{matrix}Sc ( 6 ) = {\sum }_{t ∈ {T}^{′}}^{ } \frac{1}{( \frac{1}{\vert A \vert} {\sum }_{attr ∈ A}^{ } {SP}_{6} ( attr , t ) ) + 1} \\ = \frac{1}{\frac{1}{2} ( \begin{matrix}{SP}_{6} ( Jiyugaoka , {t}_{3} ) + \\ {SP}_{6} ( Midogigaoka , {t}_{3} )\end{matrix} ) + 1} \\ = \frac{1}{\frac{1}{2} ( 0 + 0 ) + 1} \\ = 1\end{matrix} \qquad [ Equation 9 ]$$

And, when the threshold value k is k=7 in FIG. 3, the calculation target attribute does not exist. Accordingly, because T′ is an empty set, the score S_{c}(7) is 0 as shown by [Equation 10].

$$\begin{matrix}Sc ( 7 ) = {\sum }_{t ∈ {T}^{′}}^{ } \frac{1}{( \frac{1}{\vert A \vert} {\sum }_{attr ∈ A}^{ } {SP}_{7} ( attr , t ) ) + 1} \\ = 0\end{matrix} \qquad [ Equation 10 ]$$

===Combination Specification Unit 206===

The combination specification unit 206 specifies a combination of attributes by which the sum of the data number of data having a certain attribute or the data number of data having any one of a plurality of attributes becomes equal to or greater than the threshold value, for every plural threshold values.

The plural threshold values are the similar values as a plurality of threshold values which the score calculation unit 203 uses. The combination specification unit 206 judges whether or not the score calculation unit 203 satisfies a predetermined condition based on a certain threshold value. Then, when the condition is satisfied, the score calculation unit 203 may send the certain above-mentioned threshold value to the combination specification unit 206. When the combination specification unit 206 receives the threshold value from the score calculation unit 203, it may specify a combination of an attribute from which the sum of the data number of data having a certain attribute or the data number of data having any one of plural attributes becomes equal to or greater than the received threshold value.

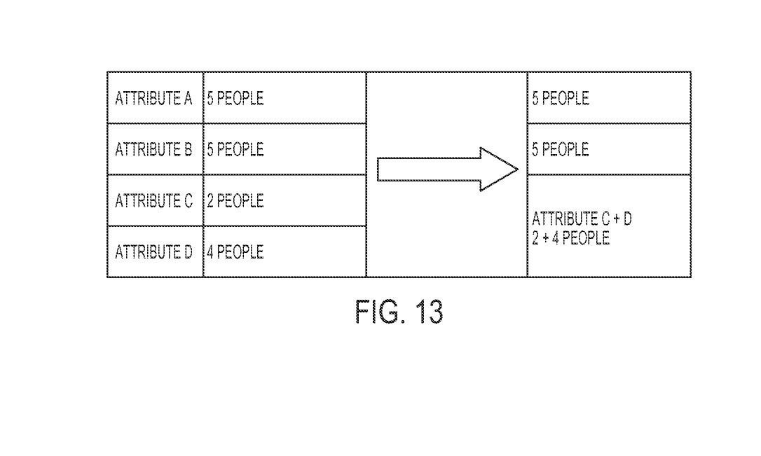

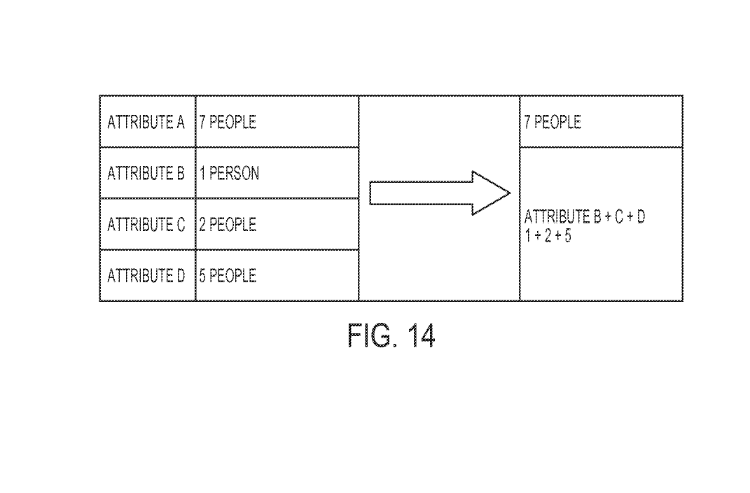

FIG. 13 and FIG. 14 are diagrams showing examples of processing of the combination specification unit 206 when threshold value k=5. For example, referring to FIG. 13, the data having the attributes c and d is less than the threshold value “5” respectively. And, the sum of the data number of data having the attributes c and d is 6, and is equal to or greater than the threshold value “5”. On the other hand, the data number of data having the attributes a and b is 5 respectively, and is equal to or greater than the threshold value “5”. Consequently, the combination specification unit 206 specifies the combination of attributes which are the attribute a, the attribute b and the attribute c+d.

Here, the combination specification unit 206 may specify a combination from which the data number of data which correspond to a combination including a plurality of attributes becomes the minimum. Data which correspond to the combination including a plurality of attributes is dealt with as a target of anonymization processing. Therefore, the combination by which the data number of the corresponding data becomes the minimum reduces the quantity of losses of an amount of information on the basis of anonymization processing.

And, for example, referring to FIG. 14, the data having the attributes b and c is less than the threshold value “5” respectively. And, the data number of data having the attributes a and d is equal to or greater than the threshold value “5” respectively. Here, the sum of the data number of data having the attributes b and c is “3” and is still less than the threshold value. In this case, the combination specification unit 206 adds an attribute of data having the data number which is equal to or greater than the threshold value and the minimum to the combination of the attributes of data of the data number which is less than the threshold value. Namely, the combination specification unit 206 specifies the combination of the attributes which are the attribute a and the attribute b+c+d.

===Anonymization Data Specification Unit 205===

The anonymization data specification unit 205 specifies data having each of the attribute as a data to be updated to a commonized attribute, when a plurality of attributes is included in the combination which the combination specification unit 206 specifies. The other functions provided in the anonymization data specification unit 205 are similar to the anonymization data specification unit 105 according to the first exemplary embodiment.

For example, the commonized attribute may be an attribute which shows a common superordinate concept to each attribute included in the above-mentioned combination. For example, in case of an example of FIG. 4, the anonymization data specification unit 205 specifies data having the attributes “Jiyugaoka” and “Nakameguro” as data by updated from the attribute which each possesses to the attribute “Meguro-ku”. And, when hierarchical relation exists between each attribute included in the above-mentioned combination, the commonized attribute may be an attribute which shows a superordinate concept in each above-mentioned attribute. For example, in case of the example of FIG. 4, when one attribute is the attribute “Jiyugaoka” and other attribute is “Meguro-ku”, the anonymization data specification unit 205 may operate as follows. Namely, the anonymization data specification unit 205 may specify the data having the attributes “Jiyugaoka” and “Meguro-ku” as data updated from the attribute which each possesses to the attribute “Meguro-ku”. Further, the one attribute here is an attribute which satisfies “the first condition” in processing in the anonymization data specification unit 105 according to the first exemplary embodiment. The first condition is that the data number of data having the one attribute is less than the anonymization index which the threshold value specification unit 104 specifies.

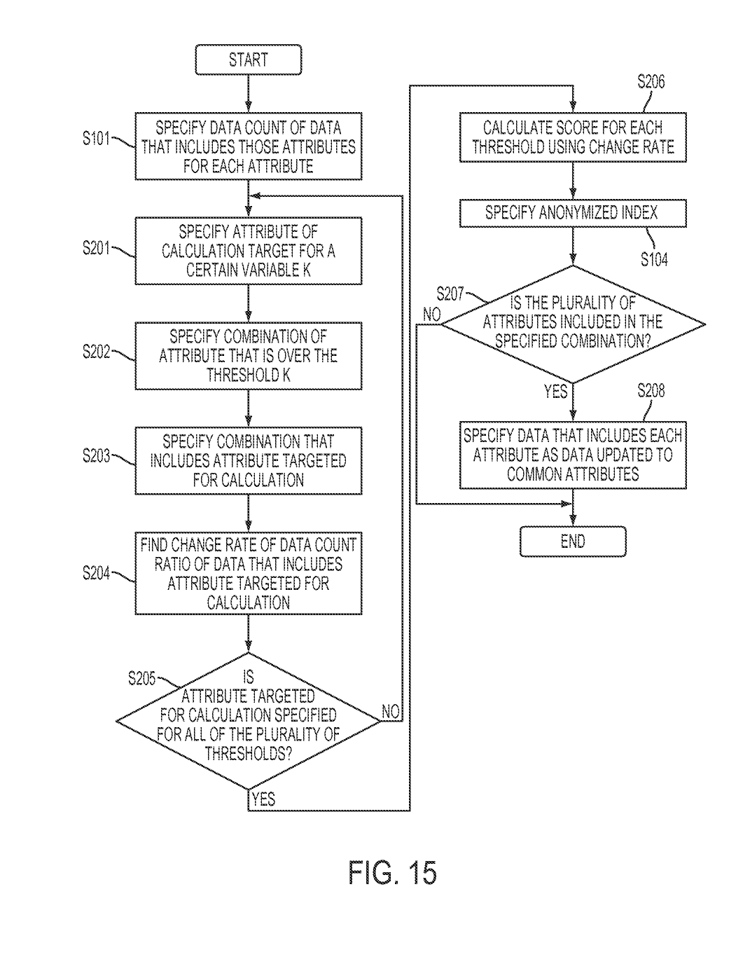

FIG. 15 is a flow chart showing an outline of operation of the anonymization index determination device 200 according to the second exemplary embodiment.

In data which the data management unit 101 manages, the data number specification unit 102 specifies the data number of data having the attribute for each attribute (Step S101).

The score calculation unit 203 specifies an attribute (calculation target attribute) which satisfies the following two conditions to a certain threshold value k in a plurality of threshold values (Step S201). The first condition is that the data number of data having the attribute is equal to or greater than a certain threshold value at a first time. The second condition is that it is less than the threshold value at a second time in which unit time has passed from the first time. The score calculation unit 203 sends the threshold value k to the combination specification unit 206.

The combination specification unit 206 specifies the combination of attributes by which the data number of data having a certain attribute or the sum of the data number of data having any one of a plurality of attributes becomes equal to or greater than the threshold value k with regards to threshold value k (Step S202).

The score calculation unit 203 specifies a combination including a calculation target attribute specified at Step S201 from the combination which the combination specification unit 206 specifies (Step S203). Then, the score calculation unit 203 calculates the rate of change of the ratio that the data number of data including the calculation target attribute occupies in the sum of the data number of data having each attribute included in the specified combination for each attribute included in the above-mentioned combination (Step S204).

The score calculation unit 203 judges whether or not the calculation target attributes are specified to all of the plurality of threshold values (Step S205).

When the score calculation unit 203 judges that there is a threshold value to which the calculation target attribute is not specified (“No” of Step S205), processing of the anonymization index determination device 200 returns to Step S201 and repeats the similar processing.

On the other hand, when the score calculation unit 203 judges that it specifies the calculation target attributes to all of the plurality of threshold values (“Yes” of Step S205), processing of the anonymization index determination device 200 goes to Step S206.

The score calculation unit 203 calculates the score for each threshold value using the above-mentioned rate of change (Step S206).

The threshold value specification unit 104 specifies the anonymization index which is one specified threshold value based on the calculated score in the plurality of threshold values which the score calculation unit 203 used (Step S104).

The anonymization data specification unit 205 judges whether or not a plurality of attributes is included in the combination which the combination specification unit 206 specified (Step S207).

When the anonymization data specification unit 205 judges that a plurality of attributes are included in the combination which the combination specification unit 206 specified (“Yes” of Step S207), it specifies the data having the each attribute as data to be updated to a commonized attribute (Step S208). Then, processing of the anonymization index determination device 200 ends.

On the other hand, when the anonymization data specification unit 205 judges that a plurality of attributes are not included in the combination which the combination specification unit 206 specified (“No” of Step S207), processing of the anonymization index determination device 200 ends.

The anonymization index determination device 200 according to the second exemplary embodiment specifies the combination of attributes by which the data number of data having a certain attribute or the sum of the data number of data having any one of a plurality of attributes becomes equal to or greater than the threshold value. Then, the anonymization index determination device 200 specifies the sum of the data number of data having each attribute included in a combination including the predetermined attributes from the specified combinations. The anonymization index determination device 200 calculates the rate of change from the value at the first time to the value in the second time of the ratio that the data number of data having the predetermined attributes occupies in the sum for each attribute. The anonymization index determination device 200 calculates the score for specifying an anonymization index on the basis of the rate of change.

The calculated rate of change shows a probability that pre-anonymization data is analogized from anonymization data. Namely, a data with a large rate of change has a large ratio between attributes of the data number before and after anonymization processing. Therefore, the data with a large rate of change has a small probability that the pre-anonymization data is analogized. On the other hand, a data with a small rate of change has a small ratio between attributes of the data number before and after anonymization processing. Therefore, the data with a small rate of change has a large probability that the pre-anonymization data is analogized.

The anonymization index determination device 200 according to the second exemplary embodiment calculates the score for specifying the anonymization index on the basis of the probability that a pre-anonymization data is analogized. Therefore, the anonymization index determination device 200 can specify an appropriate index value for guaranteeing anonymity of the data, even when the data number of data included in a predetermined group increases and decreases with time, and a possibility that the pre-anonymization data is analogized is high.

### Third Exemplary Embodiment

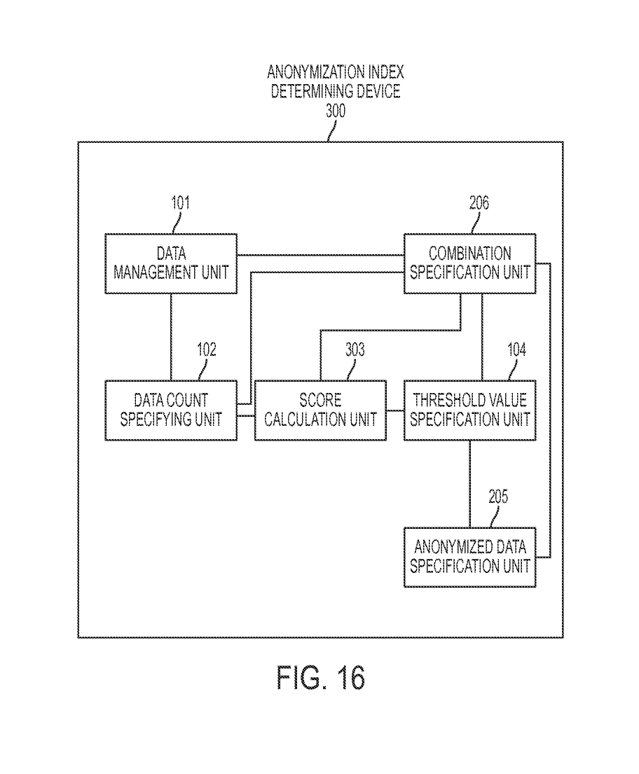

FIG. 16 is a block diagram showing an example of a configuration of an anonymization index determination device 300 in a third exemplary embodiment. Referring to FIG. 16, the anonymization index determination device 300 according to the third exemplary embodiment includes the data management unit 101, the data number specification unit 102, a score calculation unit 303, the threshold value specification unit 104, the anonymization data specification unit 205 and the combination specification unit 206.

The anonymization index determination device 300 according to the third exemplary embodiment calculates the score for specifying an anonymization index based on an information loss and the rate of change calculated using the similar method as the anonymization index determination device 200 according to the second exemplary embodiment. The information loss is information which shows an amount of information lost by anonymization processing.

When an anonymization index is specified so that anonymity of data may be guaranteed, anonymization processing by which the amount of information is lost is performed.

Therefore, the anonymization index determination device 300 according to the third exemplary embodiment guarantees anonymity of data, and also specifies an anonymization index used for anonymization processing on the basis of the amount of information lost by anonymization processing. The anonymization index determination device 300 according to the third exemplary embodiment can also specify an appropriate index value for guaranteeing anonymity of the data even when the data number of data included in a predetermined group increases and decreases with time, and a possibility which per-anonymization data is analogized is high. Moreover, the anonymization index determination device 300 according to the third exemplary embodiment can specify an appropriate index value which reduces the amount of information lost by anonymization processing.

Hereinafter, each component which the anonymization index determination device 300 according to the third exemplary embodiment includes will be described.

===Score Calculation Unit 303===

The score calculation unit 303 calculates a score for every plural threshold values on the basis of an information loss and the rate of change.

The information loss is information which is estimated based on a combination including a plurality of attributes in the combinations which the combination specification unit 206 specified, and shows the amount of information lost by anonymization processing applied to the combination. The information loss calculated to the threshold value k is information which shows the amount of information lost by anonymization processing for guaranteeing k-anonymity to the predetermined threshold value k.

For example, the information loss may be information which shows an amount of information estimated on the basis of a ratio that the sum of the data number of data having an attribute specified by the combination including plural attributes among the combinations which the combination specification unit 206 specifies occupies in the data number of data which the data management unit 101 manages.

For example, the score calculation unit 303 calculates an information loss for every plural threshold values on the basis of a calculation method shown by following [Equation 11] and [Equation 12].

In [Equation 11], the meaning of each symbol is as follows. IL(k) is an information loss of the threshold value k. T is a predetermined time. In this case, T includes time t₀, t₁, t₂ and t₃. t is each time included in T, that is, time t₀, t₁, t₂ and t₃. dₖ(t) is the function that shows the sum of the data number of data having attributes specified by a combination including a plurality of attributes. Specifically, dₖ(t) is the function calculated by using a method expressed in [Equation 12]. N(t) is the total number of the data which a data management unit 101 manages at a time t.

In [Equation 12], the meaning of each symbol is as follows. attr shows an attribute. d(attr, t) is a set of data having the attribute attr at a time t. C(t) is a combination at a time t. count(C(t)) is the function which calculates the number of attribute included in the combination C(t). P(t) is a set of combination C(t) which the combination specification unit 206 specified.

$$\begin{matrix}IL ( k ) = {\sum }_{t ∈ T}^{ } \frac{{d}_{k} ( t )}{N ( t )} & [ Equation 11 ] \\ {d}_{k} ( t ) = {\sum }_{C ( t ) ∈ P ( t )}^{ } {\sum }_{attr ∈ C ( t )}^{ } f ( d ( attr , t ) ) \\ on condition that , \\ f ( d ( attr , t ) ) = \{ \begin{matrix}\vert d ( attr , t ) \vert & ( if count ( C ( t ) ) 2 \geq ) \\ 0 & ( if count ( C ( t ) ) = 1 )\end{matrix} & [ Equation 12 ]\end{matrix}$$

[Equation 12] shows that dₖ(t) is a sum of the data number of data having attribute attr specified by the combination C(t) including a plurality of attributes.

The following is an example of calculation of the information loss about data shown in FIG. 3. In FIG. 3, in case of the threshold value k=5, the set P(t) of the combination C(t) and the count (C(t)) are specified as shown by the following [Equation 13]. Further, in [Equation 13], the combination C(t) is written as a set of attributes included in the combination C(t) for a simplification.

P(t₀)={{Jiyugaoka},{Midorigaoka}}

P(t₁)={{Jiyugaoka,Midorigaoka}}

P(t₂)={{Jiyugaoka},{Midorigaoka}}

P(t₃)={{Jiyugaoka,Midorigaoka}}

count({Jiyugaoka,Midorigaoka})=2

count({Jiyugaoka})=1

count({Midorigaoka})=1 [Equation 13]

Therefore, in case of the threshold value k=5, dₖ(t) (=d5(t)) at each time is calculated as shown by the following [Equation 14].

d₅(t₀)=0+0=0

d₅(t₁)=|d(Jiyugaoka,t₁)|+|d(Midorigaoka,t₁)|=4+3=7

d₅(t₂)=0+0=0

d₅(t₃)=|d(Jiyugaoka,t₃)|+|d(Midorigaoka,t₃)|=4+4=8 [Equation 14]

Accordingly, the information loss IL(5) in case of k=5 is calculated as shown by [Equation 15].

$$\begin{matrix}IL ( 5 ) = {\sum }_{t ∈ T}^{ } \frac{{d}_{5} ( t )}{N ( t )} \\ = \frac{0}{10} + \frac{7}{7} + \frac{0}{12} + \frac{8}{8} \\ = 2\end{matrix} \qquad [ Equation 15 ]$$

Similarly, in FIG. 3, information losses in case of the threshold values k=6 and K=7 are calculated as shown by [Equation 16], respectively.

$$\begin{matrix}\begin{matrix}IL ( 6 ) = \frac{10}{10} + \frac{7}{7} + \frac{0}{12} + \frac{8}{8} \\ = 3\end{matrix} & [ Equation 16 ] \\ \begin{matrix}IL ( 7 ) = \frac{10}{10} + \frac{7}{7} + \frac{12}{12} + \frac{8}{8} \\ = 4\end{matrix} & \end{matrix}$$

And, the score calculation unit 303 calculates a rate of change for each of plural threshold values based on the similar method as the processing of the score calculation unit 203 according to the second exemplary embodiment. Then, the score calculation unit 303 calculates the privacy loss PL(k) for each of plural threshold values on the basis of the above-mentioned rate of change.

The score calculation unit 303 calculates an information loss to each of plural threshold values. Then, the score calculation unit 303 calculates the score for each of plural threshold values on the basis of the calculated information loss and the privacy loss.

Specifically, the score calculation unit 303 calculates the score for each of plural threshold values based on the following method shown by the following [Equation 17].

$$\begin{matrix}Sc ( k ) = {α}_{1} ( IL ( k ) + {β}_{1} ) \times {α}_{2} ( PL ( k ) + {β}_{2} ) \\ = {α}_{1} ( ( {\sum }_{t ∈ T}^{ } \frac{\vert M ( t ) \vert}{\vert N ( t ) \vert} ) + {β}_{1} ) \times \\ {α}_{2} ( ( {\sum }_{t ∈ {T}^{′}}^{ } \frac{1}{( \frac{1}{\vert A \vert} {\sum }_{attr ∈ A}^{ } {SP}_{k} ( attr , t ) ) + 1} ) + {β}_{2} )\end{matrix} \qquad [ Equation 17 ]$$

In [Equation 17], α₁, α₂, β₁ and β₂ are the optional fixed numbers respectively.

For example, when values of α₁, α₂, β₁ and β₂ are 1 respectively, the score calculation unit 303 calculates the scores Sc(k) of the threshold values k=5, 6 and 7 as shown by [Equation 18] to [Equation 20] respectively.

$$\begin{matrix}\begin{matrix}Sc ( 5 ) = ( IL ( 5 ) + 1 ) \times ( PL ( 5 ) + 1 ) \\ = ( ( {\sum }_{t ∈ T}^{ } \frac{\vert M ( t ) \vert}{\vert N ( t ) \vert} ) + 1 ) \times \\ ( ( {\sum }_{t ∈ {T}^{′}}^{ } \frac{1}{( \frac{1}{\vert A \vert} {\sum }_{attr ∈ A}^{ } {SP}_{5} ( attr , t ) ) + 1} ) + 1 ) \\ = 3 \times \frac{158}{55} \approx 8.62\end{matrix} & [ Equation 18 ] \\ \begin{matrix}Sc ( 6 ) = ( IL ( 6 ) + 1 ) \times ( PL ( 6 ) + 1 ) \\ = ( ( {\sum }_{t ∈ T}^{ } \frac{\vert M ( t ) \vert}{\vert N ( t ) \vert} ) + 1 ) \times \\ ( ( {\sum }_{t ∈ {T}^{′}}^{ } \frac{1}{( \frac{1}{\vert A \vert} {\sum }_{attr ∈ A}^{ } {SP}_{6} ( attr , t ) ) + 1} ) + 1 ) \\ = 4 \times 2 \\ = 8\end{matrix} & [ Equation 19 ] \\ \begin{matrix}Sc ( 7 ) = ( IL ( 7 ) + 1 ) \times ( PL ( 7 ) + 1 ) \\ = ( ( {\sum }_{t ∈ T}^{ } \frac{\vert M ( t ) \vert}{\vert N ( t ) \vert} ) + 1 ) \times \\ ( ( {\sum }_{t ∈ {T}^{′}}^{ } \frac{1}{( \frac{1}{\vert A \vert} {\sum }_{attr ∈ A}^{ } {SP}_{7} ( attr , t ) ) + 1} ) + 1 ) \\ = 5 \times 1 \\ = 5\end{matrix} & [ Equation 20 ]\end{matrix}$$

The score calculation unit 303 may calculate an information loss for each of plural threshold values based on the above-mentioned abstraction tree. Specifically, the score calculation unit 303 may calculate an information loss on the basis of the following each step.

Firstly, the score calculation unit 303 specifies a node to which each attribute included in the combination C(t) corresponds in the above-mentioned abstraction tree.

Secondly, the score calculation unit 303 specifies a node which is a superordinate concept (a parent or a root of a tree) for all the nodes in the abstraction tree of each specified attribute.

Thirdly, the score calculation unit 303 calculates the difference in the hierarchies to the node of the above-mentioned superordinate concept about each of the nodes in the abstraction tree of each specified attribute. This difference shows the difference in the level of abstraction of the attribute of a data before and after abstraction processing. The abstraction level increases so that this difference is large, and the quantity of losses of information becomes large.

The following description is an example of the third above-mentioned processing of the score calculation unit 303 on the basis of the abstraction tree shown in FIG. 4.

When the attributes “Jiyugaoka”, “Nakameguro” and “Minato-ku” are included in the combination C(t), the score calculation unit 303 specifies a node on the abstraction tree to which each attribute corresponds. Then, the score calculation unit 303 specifies a node which is a superordinate concept for all of each specified node. In an example of FIG. 4, the score calculation unit 303 specifies the attribute “Tokyo special ward” as a node which is the above-mentioned superordinate concept. Then, the score calculation unit 303 calculates the hierarchical difference between the node to which each corresponds for each attribute included in the combination C(t) and the node “Tokyo special ward” which is the above-mentioned superordinate concept. Referring to FIG. 4, the score calculation unit 303 calculates the hierarchical difference of “Jiyugaoka” and “Tokyo special ward” as “2”. And, the score calculation unit 303 calculates the hierarchical difference of “Nakameguro” and “Tokyo special ward” as “2”. The score calculation unit 303 calculates the hierarchical difference of “Minato-ku” and “Tokyo special ward” as “1”.

Fourthly, the score calculation unit 303 calculates an information loss based on the ratio that the sum of the data number of data having attributes specified by the combination including a plurality of attributes in the combination which the combination specification unit 206 specified occupies in the data number of data which the data management unit 101 manages, and the above-mentioned hierarchical difference.

For example, the score calculation unit 303 calculates an information loss on the basis of a calculation method shown by the following [Equation 21] and [Equation 22].

In [Equation 21], the meaning of each symbol is as follows. IL(k) is an information loss in the threshold value k. T is a predetermined time. In this case, for example, T includes time t₀, t₁, t₂ and t₃. In this case, t is each time included in T, that is, time t₀, t₁, t₂ and t₃. dₖ(t) is the function that shows the sum of the data number of data having the attribute specified by the combination including a plurality of attributes. Specifically, the dₖ(t) is the function calculated by using a method expressed in [Equation 22]. N(t) is the total number of the data which the data management unit 101 manages at the time t.

In [Equation 22], the meaning of each symbol is as follows. attr shows an attribute. d(attr, t) is a set of data having the attribute attr at the time t. C(t) is a combination at the time t. count (C(t)) is the function that calculates the number of the attributes included in the combination C(t). P(t) is a set of the combination C(t) which the combination specification unit 206 specified. A m(attr, t) is the hierarchical difference to a node which shows a superordinate concept for those all about each of the nodes in an abstraction tree corresponding to each attribute included in C(t) including the attribute attr.

$$\begin{matrix} IL ( k ) = {\sum }_{t ∈ T}^{ } \frac{{d}_{k} ( t )}{N ( t )} & [ Equation 21 ] \\ {d}_{k} ( t ) = {\sum }_{C ( t ) ∈ P ( t )}^{ } {\sum }_{attr ∈ C ( t )}^{ } f ( d ( attr , t ) ) \\ on condition that , \\ f ( d ( attr , t ) ) = \{ \begin{matrix}Δ m ( attr , t ) \times \vert d ( attr , t ) \vert & ( if count ( C ( t ) ) \geq 2 ) \\ 0 & ( if count ( C ( t ) ) = 1 )\end{matrix} & [ Equation 22 ]\end{matrix}$$

[Equation 22] shows that dₖ(t) is a product of the sum of the data number of data having the attribute attr specified by the combination C(t) including a plurality of attributes and the difference of abstraction level of the attribute of data having the attribute attr before and after abstraction processing.

In the above-mentioned example, the score calculation unit 303 used the ratio that the sum of a data number of data having attributes specified by the combination including a plurality of attributes in the combination which the combination specification unit 206 specified occupies in the data number of data which the data management unit 101 manages. However, the score calculation unit 303 does not need to be based on this ratio. In this case, for example, the score calculation unit 303 may calculate an information loss for each of plural threshold values on the basis of the above-mentioned abstraction tree. In this case, for example, the score calculation unit 303 calculates an information loss on the basis of a calculation method shown by the following [Equation 23] and [Equation 24].

$$\begin{matrix} IL ( k ) = {\sum }_{t ∈ T}^{ } \frac{{d}_{k} ( t )}{N ( t )} & [ Equation 23 ] \\ {d}_{k} ( t ) = {\sum }_{C ( t ) ∈ P ( t )}^{ } {\sum }_{attr ∈ C ( t )}^{ } f ( d ( attr , t ) ) \\ on condition that , \\ f ( d ( attr , t ) ) = \{ \begin{matrix}Δ m ( attr , t ) & ( if count ( C ( t ) ) \geq 2 ) \\ 0 & ( if count ( C ( t ) ) = 1 )\end{matrix} & [ Equation 24 ]\end{matrix}$$

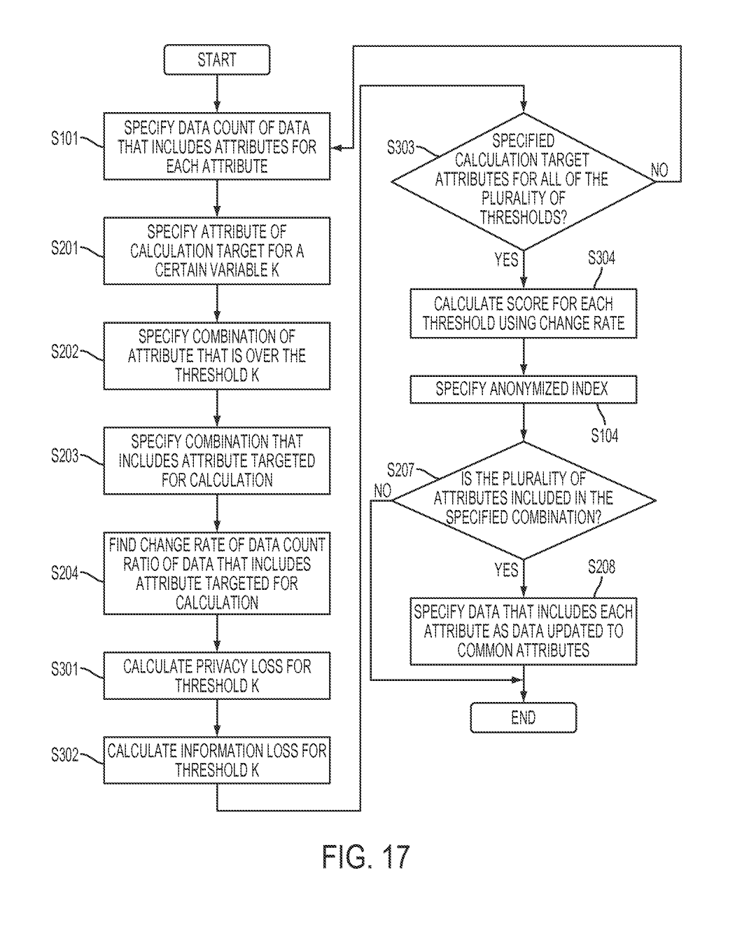

FIG. 17 is a flow chart showing an outline of operation of the anonymization index determination device 300 according to the third exemplary embodiment.

The data number specification unit 102 specifies the data number of data having the attributes for each attribute in data which the data management unit 101 manages (Step S101).

The score calculation unit 303 specifies an attribute (calculation target attribute) which satisfies the following two conditions to a certain threshold value k in a plurality of threshold values (Step S201). The first condition is that the data number of data having the attribute is equal to or greater than a certain threshold value at a first time. The second condition is that it is less than the threshold value at a second time in which unit time has passed from the first time. The score calculation unit 303 sends the threshold value k to the combination specification unit 206.

The combination specification unit 206 specifies a combination of attributes by which the data number of data having a certain attribute, or the sum of the data number of data having any one of a plurality of attributes becomes equal to or greater than the threshold value k with regards to the threshold value k (Step S202). Here, the combination specification unit 206 may specify the combination by which the data number corresponding to the combination including a plurality of attributes becomes the minimum.

The score calculation unit 303 specifies the combination including a calculation target attribute specified at Step S201 from the combinations which the combination specification unit 206 specified (Step S203). Then, a score calculation unit 303 calculates the rate of change of the ratio that the data number of data including the calculation target attribute occupies in the sum of the data number of data having each attribute included in the specified combination for each attribute included in the above-mentioned combination (Step S204).

The score calculation unit 303 calculates a privacy loss to the above-mentioned threshold value k using the above-mentioned rate of change (Step S301).

The score calculation unit 303 calculates an information loss to the above-mentioned threshold value k (Step S302).

The score calculation unit 303 judges whether or not it specifies calculation target attributes to all of a plurality of threshold values (Step S303).

When the score calculation unit 303 judges that there is a threshold value to which a calculation target attribute is not specified (“No” of Step S303), processing by the anonymization index determination device 300 returns to Step S201.

On the other hand, when the score calculation unit 203 judges that it specifies calculation target attributes to all of a plurality of threshold values (“Yes” of Step S303), processing by the anonymization index determination device 300 advances to Step S304.

The score calculation unit 303 calculates a score for each threshold value on the basis of the privacy loss calculated at Step S301 and the information loss calculated at Step S302 (Step S304).

The threshold value specification unit 104 specifies an anonymization index which is one threshold value specified on the basis of the calculated score from a plurality of threshold values which the score calculation unit 303 uses (Step S104).

The anonymization data specification unit 205 judges whether or not a plurality of attributes is included in the combination which the combination specification unit 206 specified (Step S207).

When the anonymization data specification unit 205 judges that a plurality of attributes are included in the combination which the combination specification unit 206 specified (“Yes” of Step S207), the anonymization data specification unit 205 specifies data having the each attribute as data to be updated to commonized attributes (Step S208). Then, the processing by the anonymization index determination device 300 ends.

On the other hand, when the anonymization data specification unit 205 judges that a plurality of attributes are not included in the combination which the combination specified part 206 specified (“No” of Step S207), processing by the anonymization index determination device 300 ends.

The anonymization index determination device 300 according to the third exemplary embodiment calculates the score for specifying an anonymization index on the basis of an information loss and the rate of change calculated using the similar method as the anonymization index determination device 200 according to the second exemplary embodiment. The information loss is information which shows an amount of information lost by anonymization processing.

When an anonymization index is specified so that anonymity of data may be guaranteed, anonymization processing by which the amount of information is lost is performed. Therefore, the anonymization index determination device 300 according to the third exemplary embodiment guarantees anonymity of data, and also specifies an anonymization index used for anonymization processing on the basis of the amount of information lost by anonymization processing. Accordingly, even when the data number of data included in a predetermined group increases and decreases with time, and a possibility that pre-anonymization data is analogized is high, the anonymization index determination device 300 according to the third exemplary embodiment can specify an appropriate index value for guaranteeing anonymity of the data. Moreover, the anonymization index determination device 300 according to the third exemplary embodiment can specify an appropriate index value which reduces the amount of information lost by the anonymization processing.

### Fourth Exemplary Embodiment

In the third exemplary embodiment, the score calculation unit 303 calculated the information loss when global recoding is applied as an anonymization method.

The score calculation unit 303 may calculate the score on the basis of an information loss when local recoding is applied as anonymization processing. And, the score calculation unit 303 may compare an information loss when global recoding is applied and an information loss when local recoding is applied. Then, the score calculation unit 303 may calculate a score using an information loss with a smaller value.

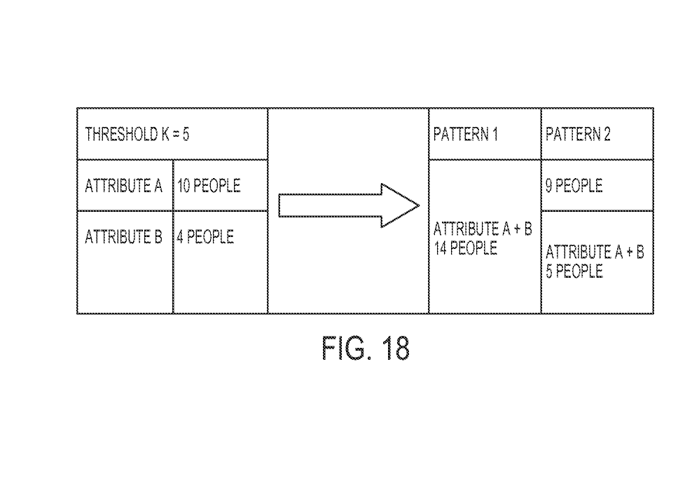

As shown in FIG. 18, an operation of the score calculation unit 303 is described as an example when the threshold value is k=5, the data number of data of the attribute A is 10, and the data number of data of the attribute B is 4.

When global recoding is applied as anonymization processing to data shown in FIG. 18, fourteen data which is the sum of ten of data having the attribute A and four of data having the attribute B are anonymized (pattern 1). Therefore, the score calculation unit 303 makes fourteen above-mentioned data the calculation objects of an information loss as target data of anonymization processing.

On the other hand, when local recoding is applied as anonymization processing, five data which is the sum of one data having the attribute A and four data having the attribute B together are anonymized (pattern 2). Therefore, the score calculation unit 303 makes five above-mentioned data the calculation objects of an information loss as target data of anonymization processing.

Specifically, the score calculation unit 303 changes the configuration of data which is included in the combination which the combination specification unit 206 specified. In case shown in FIG. 18, the score calculation unit 303 divides the combination C(t)={A, B} which the combination specification unit 206 specified into two of the combinations “C1(t)={A} and C2(t)={A, B}”. The combination C1(t) includes nine data having the attribute A. And, the combination C2(t) includes one data having the attribute A and four data having the attribute B.

In both of the pattern 1 and the pattern 2, the data number of data having one certain attribute is equal to or greater than 5 which is a threshold value. For example, in case of the pattern 1, the data number of data having the attribute A+B is 14. And, in case of the pattern 2, the data number of data having the attribute A is 9, and the data number of data having the attribute A+B is 5. Accordingly, each case of the pattern 1 and the pattern 2 satisfies k-anonymity in case of k=5.

The score calculation unit 303 calculates an information loss in case of the pattern 1, and an information loss in case of the pattern 2. Then, the score calculation unit 303 compares the calculation results. Specifically, the score calculation unit 303 calculates the respective information loss using the methods shown by the above-mentioned [Equation 11] and [Equation 12]. In case of the pattern 1, the information loss IF(5) is 14/14=1. And, in case of the pattern 2, the information loss IF(5) is 5/14.

Therefore, the score calculation unit 303 calculates the score using the information loss IF(5)=5/14 in case of the pattern 2.

When an information loss using the pattern 2 (local recoding) is used for a score calculation, the anonymization data specification unit 205 specifies data to be updated to commonized attributes on the basis of the combination of which the score calculation unit 303 changed the configuration.

In the fourth exemplary embodiment, the score calculation unit 303 may calculate an information loss for each combination which the combination specification unit 206 specifies. In that case, the score calculation unit 303 may judge whether which information loss of each global recoding and local recoding is small for each combination.

The anonymization index determination device 300 according to the fourth exemplary embodiment changes a configuration of the combination of data so that an anonymization method with a smaller information loss is selected based on the data number of data which does not satisfy k-anonymity and the data number of data which satisfies k-anonymity. Therefore, the anonymization index determination device 300 according to the fourth exemplary embodiment can take the similar effect as the anonymization index determination device 300 according to the third exemplary embodiment and can specify an appropriate index value which further reduces the amount of information lost by the anonymization processing.

One example of the effect of the present invention is able to specify an appropriate index value for guaranteeing anonymity of the data even when the data number of data included in a predetermined group increases and decreases with time.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

And, each component according to each exemplary embodiment of the present invention can be realized by a computer and a program as well as realizing the function of hardware. The program is provides by recorded in a computer readable medium such as a magnetic disk or a semiconductor memory, and is read to the computer when the computer stars up and so on. This read program controls movements of the computer and operates the computer as a component of each exemplary embodiment mentioned above.

This application is based upon and claims the benefit of priority from Japanese patent application No. 2011-136488, filed on Jun. 20, 2011, the disclosure of which is incorporated herein in its entirety by reference.

### INDUSTRIALLY APPLICABLE

An anonymization index determination device according to the present invention can be applied to a sensitive data management system in which the data number of data which are managed are varied with time.

### DESCRIPTION OF SYMBOL

10 anonymization processing execution system
100, 200, 300 anonymization index determination device
101 data management unit
102 data number specification unit
103, 203, 303 score calculation unit
104 threshold value specification unit
105, 205 anonymization data specification unit
111 anonymization execution unit
112 post-anonymization data storage unit
191 CPU
192 communication I/F
193 memory
194 storage device
195 input device
196 output device
197 bus
198 recording medium
206 combination specification unit

1. An anonymization index determination device comprising:
a data management unit which manages data having an attribute;
a data number specification unit which specifies the data number of data having the attribute at each time of a predetermined time for each attribute with regards to the data;
a score calculating unit which calculates the number of times that the data number of data having one attribute is equal to or greater than the threshold values at a first time and is less than the threshold values at a second time in which unit time has passed from the first time to a plurality of threshold values, and calculates a score for each threshold value on the basis of the number of times;
a threshold value specification unit which specifies an anonymization index from the plurality of threshold values on the basis of the score as one threshold value specified; and
an anonymization data specification unit which specifies the data having the one attribute and other attribute as data to be updated to commonized attribute, when the data number of data having one attribute in the managed data is less than the anonymization index and the sum of the data number and the data number of data having at least one or more other attributes is equal to or greater than the anonymization index.

2. The anonymization index determination device according to claim 1 comprising:
a combination specification unit which specifies a combination of attributes in which the data number of data having a certain attribute, or the sum of the data number of data having any one of a plurality of attributes is equal to or greater than the threshold value for the threshold value, wherein
said score calculating unit calculates a rate of change from a value of the first time to a value of the second time about a value of a ratio of the data number of data including the one attribute which occupies in the sum of the data number of data having each attribute included in the combination including the one attribute in the combination which said combination specification unit specifies for each attribute, and calculates the score on the basis of the rate of change for each attribute, and
said anonymization data specification unit specifies each data having the plurality of attributes as a data to be updated to commonized attribute when a plurality of attributes are included in the specified combination.

3. The anonymization index determination device according to claim 2, wherein
said score calculating unit calculates the score for each threshold value on the basis of the sum between time of the predetermined time of a reciprocal of a value on the basis of an average between the attributes of the rate of change.

4. The anonymization index determination device according to claim 2, wherein
said score calculating unit calculates an information loss which is information showing a certain amount of information estimated on the basis of the combination including a plurality of attributes in the combination to each of the plurality of threshold values, and calculates the score for each threshold value on the basis of the information loss and the rate of change.

5. The anonymization index determination device according to claim 4, wherein
said combination specification unit specifies the combination so that the sum of the data number of data having an attribute specified by the combination including a plurality of attributes in the combination becomes the minimum.

6. The anonymization index determination device according to claim 4, wherein
said score calculating unit calculates the information loss for each of the combination and calculates the sum of them,
said score calculating unit calculates the information loss to the combination as the threshold value when the data number of data having a first attribute of the combination is less than the threshold value, the data number of data having a second attribute of the combination is equal to or greater than the threshold value, and the sum of the data number of data having the first attribute and the data number of data having the second attribute is equal to or greater than a value which is determined on the basis of the threshold value, and
said anonymization data specification unit specifies data of a number shown by a difference with the data number of data having the first attribute from the data having the first attribute and the threshold value in the data having the second attribute as a data to be updated to commonized attribute.

7. The anonymization index determination device according to any one of claim 1, wherein
said score calculating unit calculates the score to the plurality of threshold values including the anonymization index when the anonymization index which said threshold value specification unit specifies is equal to or greater than a predetermined value.

8. The anonymization index determination device according to any one of claim 1, comprising:
an anonymization execution unit which updates data which said anonymization data specification unit specifies to the commonized attribute.

9. An anonymization processing execution system comprising:
said anonymization index determination device according to any one of claim 1;
an anonymization execution unit which updates data which said anonymization data specification unit specifies to the commonized attribute; and
a post-anonymization data storage unit which stores the data which said anonymization execution unit updates.

10. An anonymization index determination method comprising:
managing data having an attribute;
specifying the data number of data having the attribute at each time of a predetermined time for each attribute with regards to the data;
calculating the number of times that the data number of data having one attribute is equal to or greater than the threshold values at a first time and less than the threshold values at a second time in which unit time has passed from the first time to a plurality of threshold values, and calculating a score for each threshold value on the basis of the number of times;
specifying an anonymization index from the plurality of threshold values on the basis of the score as one threshold value specified; and
specifying the data having the one attribute and the other attribute as data to be updated to commonized attribute, when the data number of data having one attribute in the managed data is less than the anonymization index and the sum of the data number and the data number of data having at least one or more other attributes is equal to or greater than the anonymization index.

11. An anonymization processing execution method comprising;
managing data having an attribute;
specifying the data number of data having the attribute at each time of a predetermined time for each attribute with regards to the data;
calculating, to a plurality of threshold values, the number of times that the data number of data having one attribute is equal to or greater than the threshold values at a first time and less than the threshold values at a second time in which unit time has passed from the first time, and calculating a score for each threshold value on the basis of the number of times;
specifying an anonymization index from the plurality of threshold values on the basis of the score as one a threshold value specified;
specifying the data having the one attribute and the other attribute as data to be updated to commonized attribute, when the data number of data having one attribute in the managed data is less than the anonymization index and the sum of the data number and the data number of data having at least one or more other attributes is equal to or greater than the anonymization index;
updating the specified data to the commonized attribute; and
storing the updated data.

12. A computer readable medium embodying a program, said program causing an anonymization index determination device to perform a method, said method comprising:
managing data having an attribute;
specifying the data number of data having the attribute at each time of a predetermined time for each attribute with regards to the data;
calculating the number of times that the data number of data having one attribute is equal to or greater than the threshold values at a first time and less than the threshold values at a second time in which unit time has passed from the first time to a plurality of threshold values, and calculating a score for each threshold value on the basis of the number of times;
specifying an anonymization index from the plurality of threshold values on the basis of the score as one a threshold value specified; and
specifying the data having the one attribute and the other attribute as data to be updated to commonized attribute, when the data number of data having one attribute in the managed data is less than the anonymization index and the sum of the number and the data number of data having at least one or more other attributes is equal to or greater than the anonymization index.

13. An anonymization index determination device comprising:
data management means for managing data having an attribute;
data number specification means for specifying the data number of data having the attribute at each time of a predetermined time for each attribute with regards to the data;
score calculating means for calculating the number of times that the data number of data having one attribute is equal to or greater than the threshold values at a first time and less than the threshold values at a second time in which unit time has passed from the first time to a plurality of threshold values, and calculating a score for each threshold value on the basis of the number of times;
threshold value specification means for specifying an anonymization index from the plurality of threshold values on the basis of the score as one threshold value specified; and
anonymization data specification means for specifying the data having the one attribute and other attribute as data to be updated to commonized attribute, when the data number of data having one attribute in the managed data is less than the anonymization index and the sum of the data number and the data number of data having at least one or more other attributes is equal to or greater than the anonymization index.
